(19) United States
(12) Patent Application Publication
(10) Pub. No.: US 2005/0215300 A1
(43) Pub. Date: Sep. 29, 2005

(54) Poker tournament management system

(76) Inventor: R. Martin Oliveras, Morristown, NJ (US)

Correspondence Address: R. Martin Oliveras, 7 Bell Drive, Morristown, NJ, 07960, US

(21) Appl. No.: 10/809,951

(22) Filed: Mar. 26, 2004

(51) Int. Cl. A63F 13/00

(52) U.S. Cl. 463/13

(57) ABSTRACT

According to the present invention, the poker tournament management system allows a plurality of players to participate in a player-elimination poker tournament. The system utilizes several poker tables, each poker table having several player positions. The system comprises: a central processing unit; at least one main console; and first signal transmitting means for allowing each main console and the central processing unit to send signals to each other and to receive signals from each other. Each main console further comprises player information entering means. The central processing unit responds to the player information accessed by the entering means for initially randomly assigning each participating player to a specific player position at a specific poker table. Features of the poker tournament management system are that the central processing unit utilizes a pre-stored poker table replenishment algorithm, a pre-stored poker table closure algorithm and a pre-stored poker table replenishment/re-filling algorithm for re-assigning players from donor poker tables to donee poker tables and for closing chosen donor poker tables.

### BACKGROUND OF THE INVENTION

1. Field of the Invention

This invention relates to a poker playing system and in particular to a player-elimination poker tournament management system.

2. Description of the Prior Art

Poker tournaments have experienced an increase in popularity over the past several years. This increase in poker tournament popularity has occurred mostly in legalized casinos in Nevada, California, Atlantic City, Mississippi, Europe and elsewhere. For example, the most recent World Series of Poker Tournament in Las Vegas of No Limit Texas Hold-em attracted 613 players each posting an entry fee of $10,000 with first place paying $1,500,000. Other popular poker tournament games are Limit Texas Hold-em, Pot Limit Texas Hold-em, Limit Omaha High, Pot Limit Omaha High, Limit Omaha Hi-Lo Split, Limit Seven Card Stud, and Limit Seven Card Hi-Lo Split.

Playing a poker tournament requires skill, luck and psychology. A poker tournament is best played and is most exciting when played by live players against each other using real cards at the same poker table. The initial assignment of tournament players to the poker tables, the later re-assignment of players to other tables, the initial assignment of poker dealers to the tables, the later re-assignment of dealers to the tables, the closing of tables, keeping up with the number and latest table of the remaining players, keeping up with the number and last table of the eliminated players, advising the dealers and remaining players of the changing betting limits and antes, advising the players of the tournament payoff structure are all factors which tend to slow-down the progress of the tournament. The longer the tournament takes to complete, the longer the dealers have to deal, the more money the casino has to pay the dealers, and the longer the poker tables remain unavailable for regular poker games.

Many casinos do not offer poker tournaments. Casinos prefer to offer other casino games for the following reasons: Poker tournaments are too labor intensive; Poker tournaments take up too much casino space; Poker tournaments makes too little money for the casino.

Many prior art card-playing systems disclose either new card games or modified traditional card games. Many prior art card-playing systems disclose the use of electronic cards and electronic chips all controlled and/or generated by a central computer. Many prior art card-playing systems allow numerous players to participate in the card game from remote locations. One prior art example is Nakagawa U.S. Pat. No. 5,603,502 entitled “Poker Tournament Method”. Nakagawa discloses such a tournament method wherein when the total number of players remaining in the games declines to a specific number being an exponential product of the number 2, then such players are matched into pairs each pair playing one-on-one games. Another prior art patent is Marks U.S. Pat. No. 5,755,621 entitled “Modified Poker Card/Tournament Game And Interactive Network Computer System For Implementing Same”. Marks discloses an electronic system wherein a plurality of players play a tournament game against each other and wherein individual players play a different game against the house. Mark's system comprises a central computer for effectively managing the tournament amongst the plurality of players and for managing the individual games played by the individual players against the house. None of the cited prior art patents disclose the “Poker Tournament Management System” of the present invention which controls the flow of players from their initially assigned poker tables to later re-assigned poker tables as players get eliminated from the tournament and as poker tables get closed during the tournament.

### SUMMARY OF THE INVENTION

According to the present invention, the poker tournament management system allows a plurality of players to participate in a player-elimination poker tournament. The system utilizes several poker tables, each poker table having several player positions. The system comprises: a central processing unit; at least one main console; and first signal transmitting means for allowing each main console and the central processing unit to send signals to each other and to receive signals from each other; each main console further comprising player information entering means; and the central processing unit responding to the player information accessed by the entering means for initially randomly assigning each participating player to a specific player position at a specific poker table. Features of the present invention are that the central processing unit utilizes a pre-stored poker table replenishment algorithm, a pre-stored poker table closure algorithm and a pre-stored poker table replenishment/re-filling algorithm for re-assigning players from donor poker tables to donee poker tables and for closing chosen donor poker tables.

Objects and advantages of the present invention are to: Allow a poker tournament dealer to be more efficient; Allow the dealer to deal more hands per unit time; Allow the poker tournament manager to remotely monitor the number of remaining players per poker table; Allow the manager to better distribute the number of players per poker table; and Allow the poker tournament to be more quickly terminated.

### BRIEF DESCRIPTION OF THE DRAWINGS

The above and other features, objects, and advantages of the present invention will be further appreciated from a reading of the following detailed description in conjunction with the drawing in which:

FIGS. 1a-e show top views of poker table 500 showing how the four betting rounds of a limit Holdem poker hand are played.

FIG. 2 shows a first embodiment of system 100 according to the present invention in a multiple poker table embodiment wherein a dealer console DC is located at each poker table.

FIG. 3 shows a second embodiment of system 100 according to the present invention in a multiple poker table embodiment wherein a dealer console DC and a plurality of player consoles PC are located at each poker table.

FIGS. 4a and 4b respectively show detailed views of main central processing unit CPU 300 and secondary central processing unit CPU 400 according to the present invention.

FIG. 5a shows main console MC 200 according to the present invention while FIGS. 5b-m show various touch-responsive display screens of main console MC 200.

FIG. 6a shows dealer console DC 110 according to the present invention while FIGS. 6b-m show various touch-responsive display screens of dealer console DC 110.

FIG. 7a shows player console PC 10 according to the present invention while FIGS. 7b-i show various touch-responsive display screens of player console PC 10.

FIG. 8 is a time table showing the elimination of players, the re-assignment of players, the closing of poker tables, and the replenishment/re-filling of poker tables during a poker tournament according to the present invention.

FIGS. 9a-c show the modular plug-in features of dealer console DC 110 and player consoles PC 10-19 onto poker table 1 according to the present invention.

FIGS. 10a-b show the modular plug-in features of main console MC 200 onto its support structure according to the present invention.

### DETAILED DESCRIPTION OF THE INVENTION

Limit Texas Hold-em (hereinafter called Limit Holdem) is an example of a very popular poker room game (side game) and poker tournament game. Limit Holdem is played by up to 10 players on an oval-shaped poker table. The casino dealer sits in the middle of one of the long sides of the table. The betting limits are set by the casino. The most popular Holdem limits are: $5/$10; $10/$20; $15/$30; $20/$40; $30/$60; and $50/$100. The first $ amount is the “big blind” amount. In $10/$20 limit Holdem, the big blind is $10. The “little blind” amount is $5. During the 1st and 2nd betting rounds of a poker hand, the defined bet is $10 plus up to 3 possible raises for a total maximum bet of $40. During the 3rd and 4th betting rounds, the defined bet is $20 plus up to 3 possible raises for a total maximum bet of $80.

The following detailed description relates to $10/$20 limit Holdem. Each hand of limit Holdem involves several steps taken by the casino dealer and up to four betting rounds effected by the players. The order of dealing by the casino dealer and the order of betting by the players are controlled by the designated player position called the “button”. The player who is the button is designated by a round white plastic button which is physically placed in front of that player so that the casino dealer and all the other players know which player is the button.

In $10/$20 limit Holdem, each player initially buys poker chips for no less than the minimum amount set by the casino (such as $100) and up to $1,000 or more at the discretion of the player. Each player now has a stack of chips for playing each hand of poker. Before the beginning play (before the first hand is dealt and played), the casino dealer deals each player one card face-up in clockwise order starting with the first player to the left of the dealer. The player who is dealt the highest-ranking card face-up is designated the button. The plastic button is physically placed in front of that player who was dealt the highest ranking card face-up.

There are two ways by which the casino (“the house”) makes money from a poker game. In high limit Holdem, the casino usually charges each player at the table a monetary amount (“time”) during each ½ hour. For example, in $10/$20 limit Holdem, the time amount charged each player each 30 minutes may be $5. In low limit Holdem, the casino usually takes an amount (“the rake”) being a certain maximum percentage from each pot at the end of each poker hand. For example, in $5/$10 limit Holdem, the rake may be up to a maximum of $5.

The wager options that a player has or the wager actions that a player may choose from are fold, check, call, bet or raise. Fold means that a player does not want to meet the pending bet or pending raise amount. Such player surrenders his two face-down hole cards; and such player surrenders whatever moneys he has wagered so far up to that betting round of the poker hand. Check means that a player does not want to bet when there is no pending bet or no pending raise amount. Call means that a player puts into the pot the same amount as the pending bet or pending raise amount. Bet means that a player bets the limit amount allowed during that betting round. Such bet amount may be the big blind amount or double the big blind amount depending on the betting round. Raise means that a player bets an amount greater than the pending bet or pending raise amount. Such raise may be a multiple of the big blind amount or a multiple of the double big blind amount allowed during that betting round.

Side pots are created as follows. A player must either fold, check, call, bet, or raise. Such player has a certain number of chips in front of him at that time of play. If such player is not able to call the whole pending bet or pending raise amount; or if such player is not able to make a whole bet; or if such player is not able to make a whole raise, then the dealer creates a side pot in addition to the already existing main pot. The dealer determines the reduced amount that such player can call, bet or raise. Then the dealer places that amount into the main pot times the number of active players still in the hand at that time. For example, if the all-in player has only $5 and there are 4 active players in the hand, then the dealer places $20 into the main pot. The dealer then creates the side pot from the difference that the other 3 active players further call, bet or raise. The all-in player can only win the main pot. The other 3 active players can win the main pot and/or the side pot.

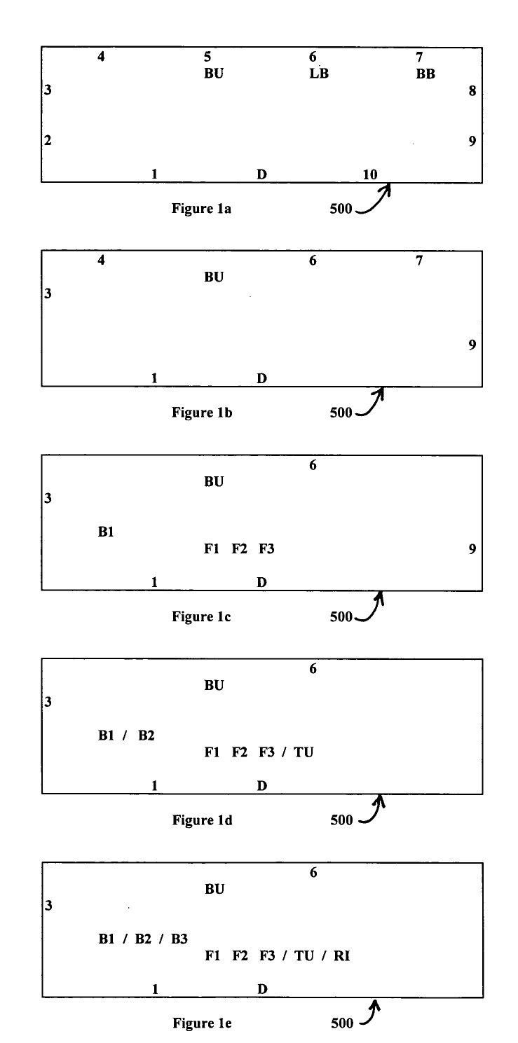

FIGS. 1a-e

FIGS. 1a-e are top views of poker table 500 showing how a limit Holdem poker hand is played. See FIG. 1a. Table 500 is shown as viewed from above. The positions of casino dealer D and of players 1-10 are shown. For explanatory purposes only, it is assumed that player 5 was dealt the highest-ranking card face-up and is therefor designated the button BU for the first hand. Therefore, round white plastic button BU is physically placed in front of player 5. Before any hand of limit Holdem is played, the most important questions asked by dealer D and by all the players at the table are: Which player is the button BU? Which player is the little blind LB? Which player is the big blind BB? In this example, player 5 is the button BU. Player 6 is the little blind LB and places a $5 chip on the table in front of him before the first hand is dealt. Player 7 is the big blind BB and places a $10 chip on the table in front of him before the first hand is dealt.

Dealer D now knows that player 5 is the button. Dealing by dealer D and betting by players 1-10 are performed in a clock-wise manner relative to player 5 who is the button BU. Each hand of limit Holdem comprises up to four betting rounds. The 1st betting round is called the pre-flop betting round; the 2nd betting round is called the post-flop betting round; the 3rd betting round is called the turn betting round; and the 4th betting round is called the river betting round. Button BU remains in place throughout all betting rounds of a poker hand. Before the pre-flop betting round, player 6 (who is the little blind LB) must place a $5 chip in front of him. Player 7 (who is the big blind BB) must place a $10 chip in front of him. Players 6 and 7 have not yet been dealt any cards by dealer D. Dealer D now deals player 6 one hole card face-down; player 7 one hole card face-down; and so on until player 5 (the button BU) is dealt one hole card face-down. Dealer D next deals each player a second hole card face-down in the same clockwise order as before. Player 8 now has three options: he may call the big blind amount of $10; he may raise by the big blind amount and make the bet $20; or he may drop out of the hand and fold by surrendering his two cards to dealer D. After player 8 exercises one of his options, then it is up to player 9 to exercise one of his options, and so on until player 5 (the button BU) exercises one of his options. Player 6 (the little blind LB who has already placed a $5 chip in front of him) may now exercise one of the following options. He may complete his bet to $10 by placing a second $5 chip in front of him if no one before him has raised to $20 or higher. He may call a higher bet if there was at least one raise before him. He may drop out and fold by surrendering his two cards and his $5 chip. If player 6 still has an option to raise and in fact does raise, then all subsequent remaining players must either meet his raise or must fold their hands. Player 7 (the big blind BB who has already placed a $10 chip in front of him) may now exercise one of the following options. He may call if no one has raised before him by pushing his $10 chip forward. He may call a higher bet if there was at least one raise before him. He may drop out of the hand and fold by surrendering his two cards and his $10 chip if there was at least one raise before him. If player 7 still has an option to raise and in fact does raise, then all subsequent remaining players must either meet his raise or must fold their hands. The maximum number of raises allowed by the casino (usually three raises) limits the aforementioned clockwise process. Once the maximum number of raises is reached at a given player, then the subsequent remaining players may only call the prior raises or may fold their hands. The total amount or value of the chips in the middle of table 500 after this 1st or pre-flop betting round is called the pot. The monetary value of the pot is dynamic because it increases each time a player calls, bets or raises. Those players remaining in the hand after the pre-flop betting round are active players. In this example, the remaining active players after the pre-flop betting round are players 6, 7, 9, 1, 3 and 4 in clockwise order relative to button BU. Players 8, 10, 2 and 5 folded (dropped out of the hand) and are inactive players during the rest of the hand. See FIG. 1b.

After the 1st or pre-flop betting round is complete, dealer D burns a card B1 face-down and places it on the table to his left. Dealer D next deals three cards F1, F2 and F3 face-up and places them on the table in front of him. These three cards are called the flop cards. The remaining active players in the hand now commence the 2nd or post-flop betting round. During the post-flop betting round, player 6 may check by not betting or may bet $10. Player 7 may check if and only if player 6 checked, or may call $10 if player 6 bet $10, or may raise to $20 if player 6 bet $10, or may fold if player 6 bet $10. Player 9 may exercise one of the same options as player 7, and so on by players 1 and 3 until player 4 exercises one of his options. If player 4 still has an option to raise and in fact does raise, then players 6, 7, 9, 1 and 3 must meet the raise or must fold. Again, the maximum number of raises allowed by the casino limits the aforementioned clockwise process. Once the maximum number of raises is reached at a given remaining active player, then the subsequent remaining active players may only call or fold. The total amount or value of the chips in the middle of the table after this 2nd or post-flop betting round is the new pot amount. Those players remaining in the hand after the post-flop betting round are active players. In this example, the remaining active players after the post-flop betting round are players 6, 9, 1 and 3 in clockwise order relative to button BU. Players 7 and 4 folded (dropped out of the hand) and are inactive players during the rest of the hand. See FIG. 1c.

After the 2nd or post-flop betting round is complete, dealer D burns another card B2 face-down and places it on the table next to burn card B1. Dealer D then deals another card TU face-up and places it on the table in line with flop cards F1, F2 and F3. The remaining active players (6, 9, 1, and 3) now commence the 3rd or turn betting round. During the turn betting round, player 6 may check by betting no amount or may bet $20. Player 9 may check if and only if player 6 checked, or may call $20 if player 6 bet $20, or may raise to $40 if player 6 bet $20, or may fold his hand if player 6 bet $20. Player 1 may exercise the same options as player 9, and so on until player 3 exercises one of his options. If player 3 raises, then players 6, 9, and 1 must either meet the raise or must fold. Again, the maximum number of raises allowed by the casino limits this clockwise process. Once the maximum number of raises is reached at a given player, then the subsequent remaining players may only call or fold. The total amount or value of the chips in the middle of the table after this 3rd or turn betting round is the new pot amount. Those players remaining in the hand after the turn betting round are active players. In this example, the remaining active players after the turn betting round are players 6, 1 and 3 in clockwise order relative to button BU. Player 9 folded (dropped out of the hand) and is an inactive player during the rest of the hand. See FIG. 1d.

After the 3rd or turn betting round is complete, dealer D burns another card B3 face-down and places it on the table next to burn cards B1 and B2. Dealer D then deals another card R1 face-up and places it on the table in line with cards F1, F2, F3 and T. The remaining active players (6, 1, 3) in the hand now commence the 4th or river betting round. During the river betting round, player 6 may check by betting no amount or may bet $20. Player 1 may check if and only if player 6 checked, or may call $20 if player 6 bet $20, or may raise to $40 if player 6 bet $20, or may fold if player 6 bet $20. Player 3 may exercise one of the same options as player 1. If player 3 raises, then players 6 and 1 must either meet the raise or must fold their hands. Again, the maximum number of raises allowed by the casino limits the aforementioned clockwise process. Once the maximum number of raises is reached at a given remaining active player, then the subsequent remaining active players may only call or fold. The total amount or value of the chips in the middle of the table after this 4th or river betting round is the final pot amount. Those players remaining in the hand after the river betting round are active players. In this example, the remaining active players after the river betting round are players 6, 1 and 3 in clockwise order relative to button BU. See FIG. 1e.

After the 4th or river betting round is complete, each remaining active player (6, 1, 3) in clockwise order relative to button B must expose his two cards face-up. Then, upon exposing his two cards face-up, each player must declare to the dealer and to the other players the best poker hand that his two cards make in combination with the five face-up cards F1, F2, F3, TU and R1 in the middle of the table. In most casinos, the dealer must read and declare out loud the best poker hand made by each player. In many cases a player will not expose his two cards because such player concedes to himself that his best poker hand does not beat the other exposed poker hands. After all the players' cards are exposed and after all the best poker hands are declared, then the dealer declares the winners of the main pot and any side pots. If two or more players make the same best poker hand, then the main pot and/or any side pots are split between/among such winning players.

A poker tournament is different from a one table poker game. Generally, only up to 10 players participate in the typical hold-em game. Several hundred players may enter and participate in a limit hold-em poker tournament. Also, many poker tables are initially used in a poker tournament. Some recent poker tournaments have started with over 70 tables. Also, many poker dealers initially start dealing in a poker tournament at least equal in number to the initial number of poker tables. Dealers must be rotated from open table to open table and must be given breaks at pre-determined time periods. Also, players are eliminated from a poker tournament once they run out of chips. This elimination of players requires the re-assignment of other players from one table to another table and the closure of tables. In a regular hold-em game the chip denominations do not change. In a poker tournament, small denomination chips are converted to larger denomination chips as the poker tournament progresses because the betting limits increase at pre-determined time periods thereby obviating the use of small denomination chips to make larger and larger bets. The general purpose of the present invention is to provide the poker tournament manager the means to efficiently manage a dynamic poker tournament.

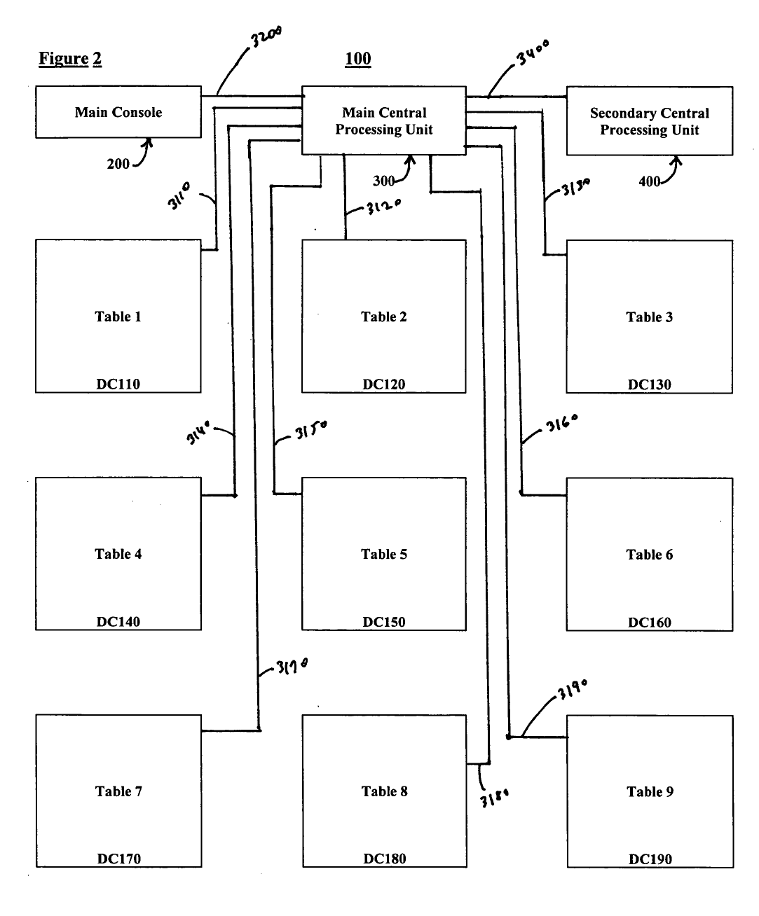

FIG. 2

FIG. 2 shows a first embodiment of system 100 according to the present invention in a multiple poker table embodiment wherein a dealer console DC is located at each poker table. System 100 comprises main central processing unit CPU 300; at least one main console MC 200; dealer consoles DC 110-190 being respectively located on poker tables 1-9; and secondary self-powered central processing unit CPU 400. Each main console MC 200 is connected to CPU 300 by signal transmitting means 3200. Dealer consoles DC 110-190 are respectively connected to CPU 300 by signal transmitting means 3110-3190. Secondary CPU 400 is connected to CPU 300 by signal transmitting means 3400. CPU 300 may send signals to and may receive signals from each main console MC 200, dealer consoles DC 110-190, and secondary CPU 400 via such respective signal transmitting means which may be wireless transmitting means.

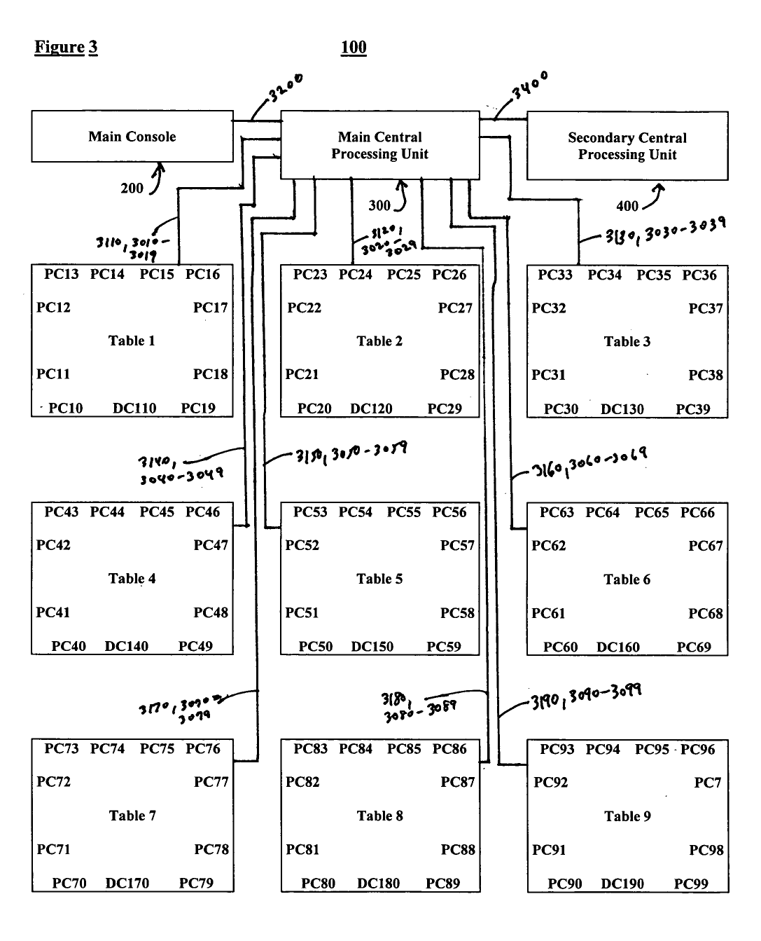

FIG. 3

FIG. 3 shows a second embodiment of system 100 according to the present invention in a multiple poker table embodiment wherein a dealer console DC and a plurality of player consoles PC are located at each poker table. System 100 comprises main central processing unit CPU 300; at least one main console MC 200; dealer consoles DC 110-190 being respectively located on poker tables 1-9; player consoles PC 10-19 being located on table 1 and so on to player consoles PC 90-99 being located on table 9; and secondary self-powered central processing unit CPU 400. Each main console MC 200 is connected to CPU 300 by signal transmitting means 3200. Dealer consoles DC 110-190 are respectively connected to CPU 300 by signal transmitting means 3110-3190. Player consoles PC 10-99 are respectively connected to CPU 300 by signal transmitting means 3010-3099. Secondary CPU 400 is connected to CPU 300 by signal transmitting means 3400. CPU 300 may send signals to and may receive signals from each main console MC 200, dealer consoles DC 110-190, player consoles PC 10-99, and secondary CPU 400 via such respective signal transmitting means which may be wireless transmitting means.

According to the present invention with respect to the embodiment of FIG. 2, main CPU 300 randomly assigns a player to an initial player position at an initial poker table or later re-assigns a player from a first player position at a donor poker table to a second player position at a donee poker table. According to the present invention with respect to the embodiment of FIG. 3, main CPU 300 in effect randomly assigns a player to an initial player console position at an initial poker table or later re-assigns a player from a first player console position at a donor poker table to a second player console position at a donee poker table.

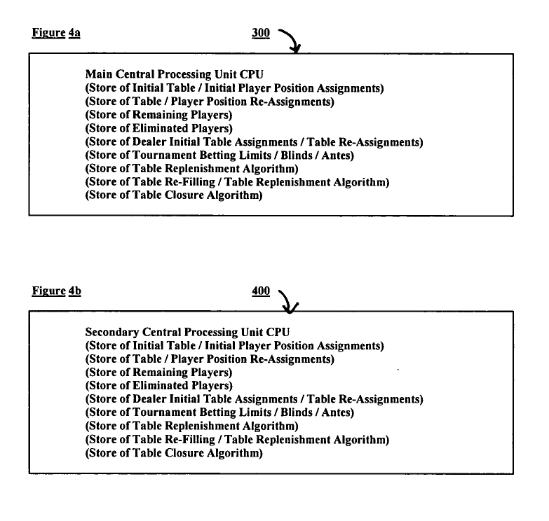

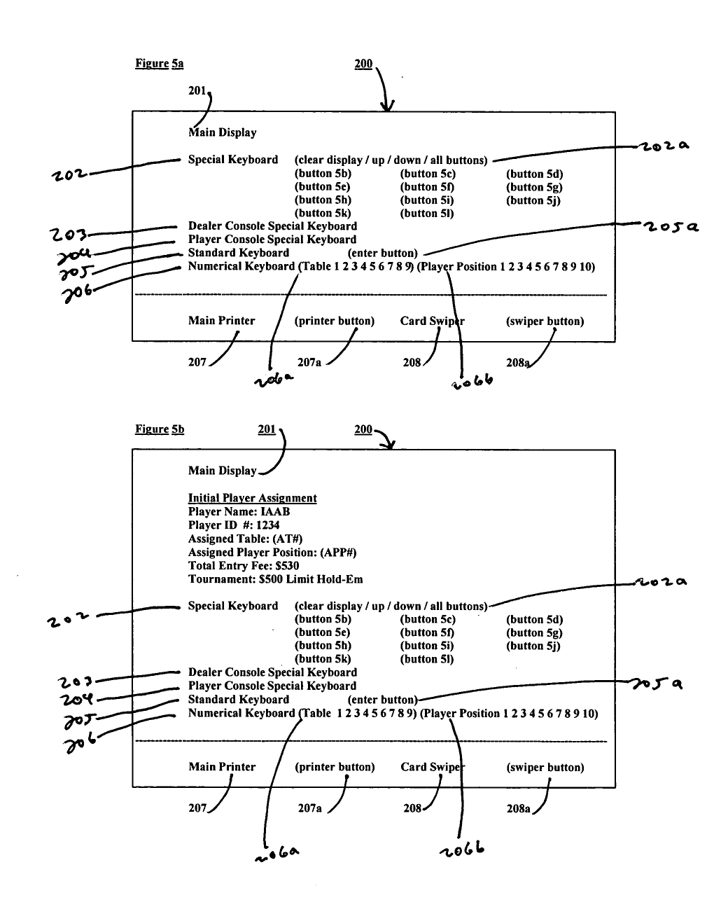

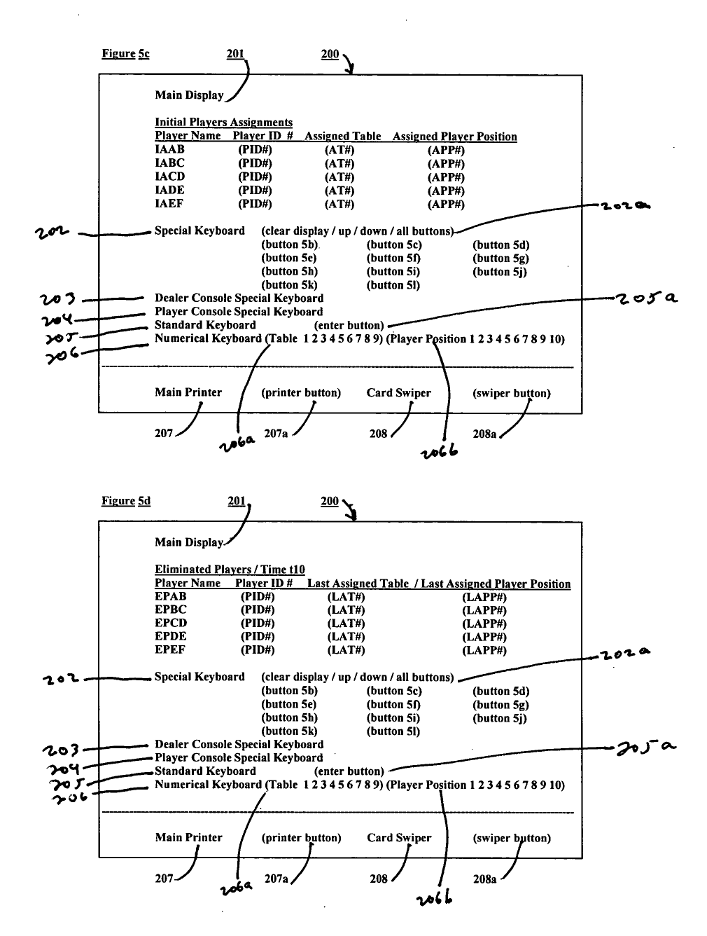

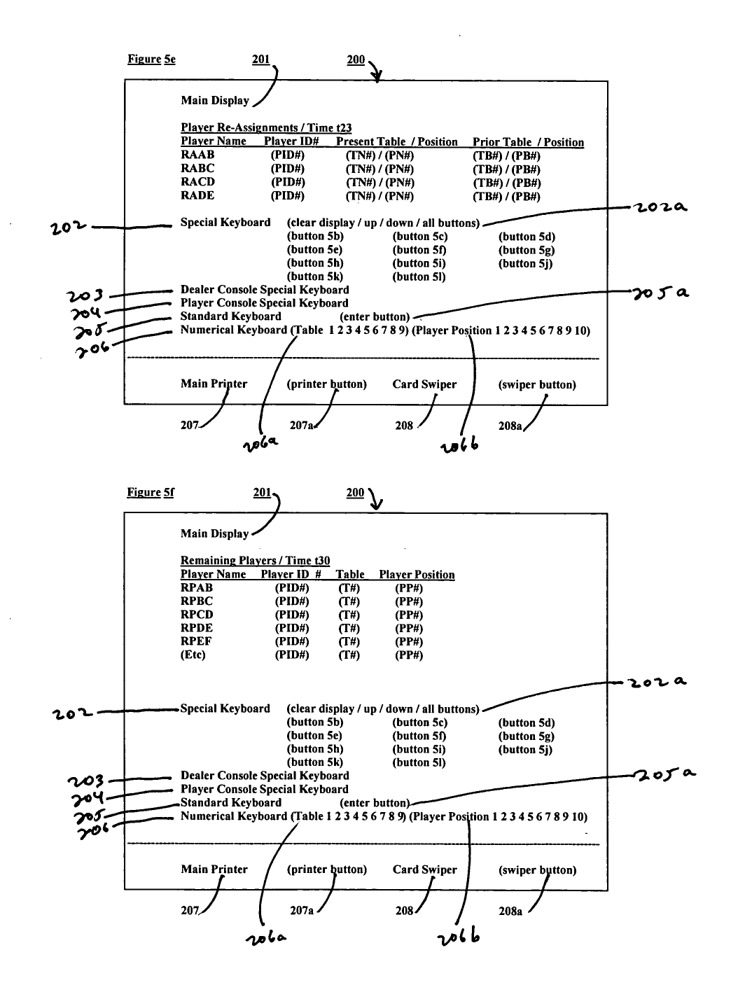

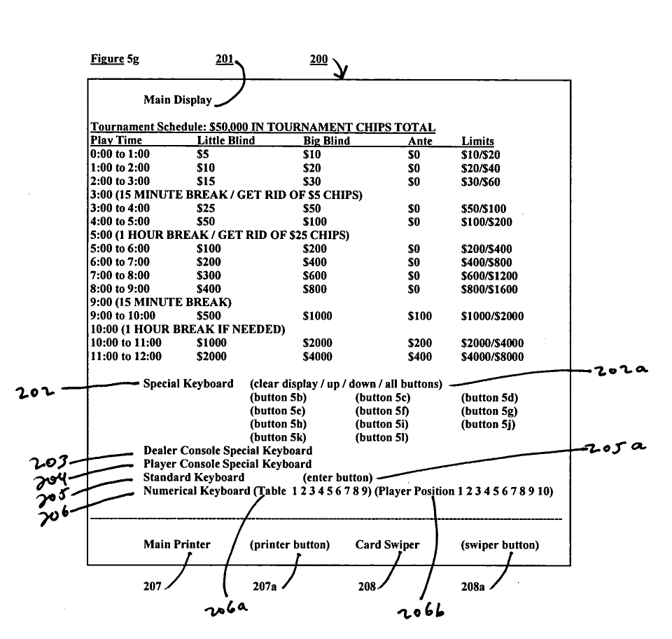

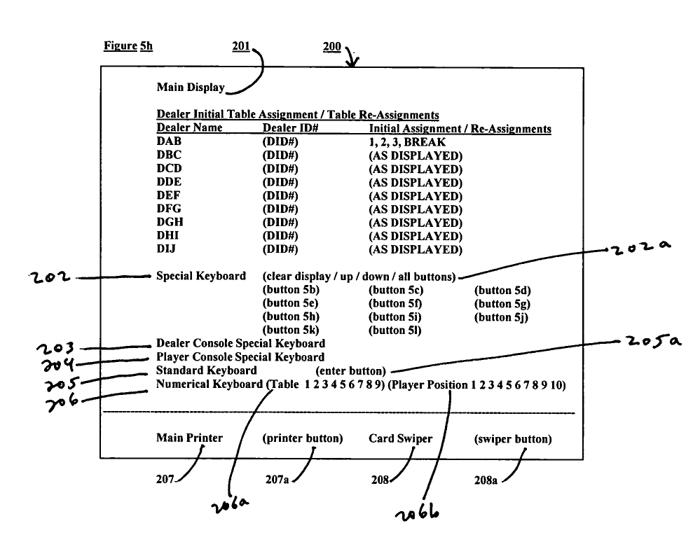

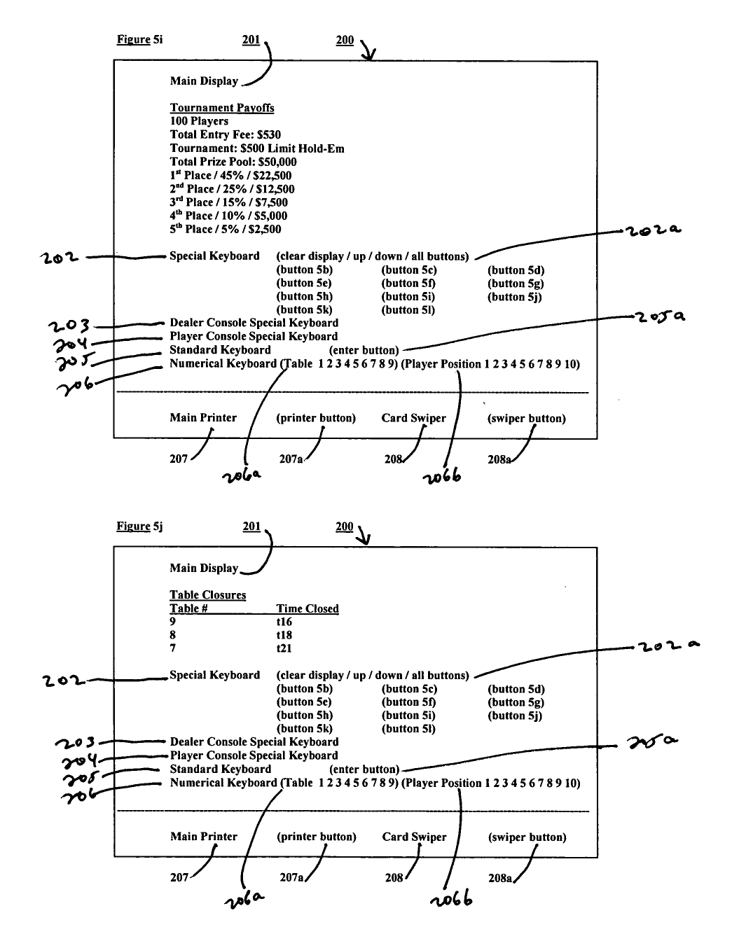

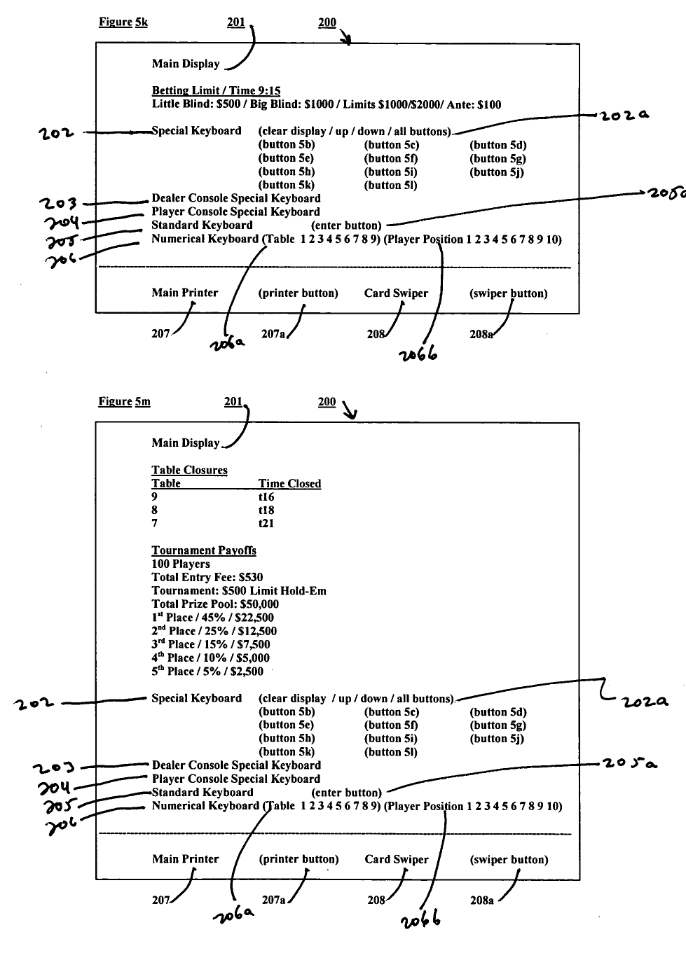

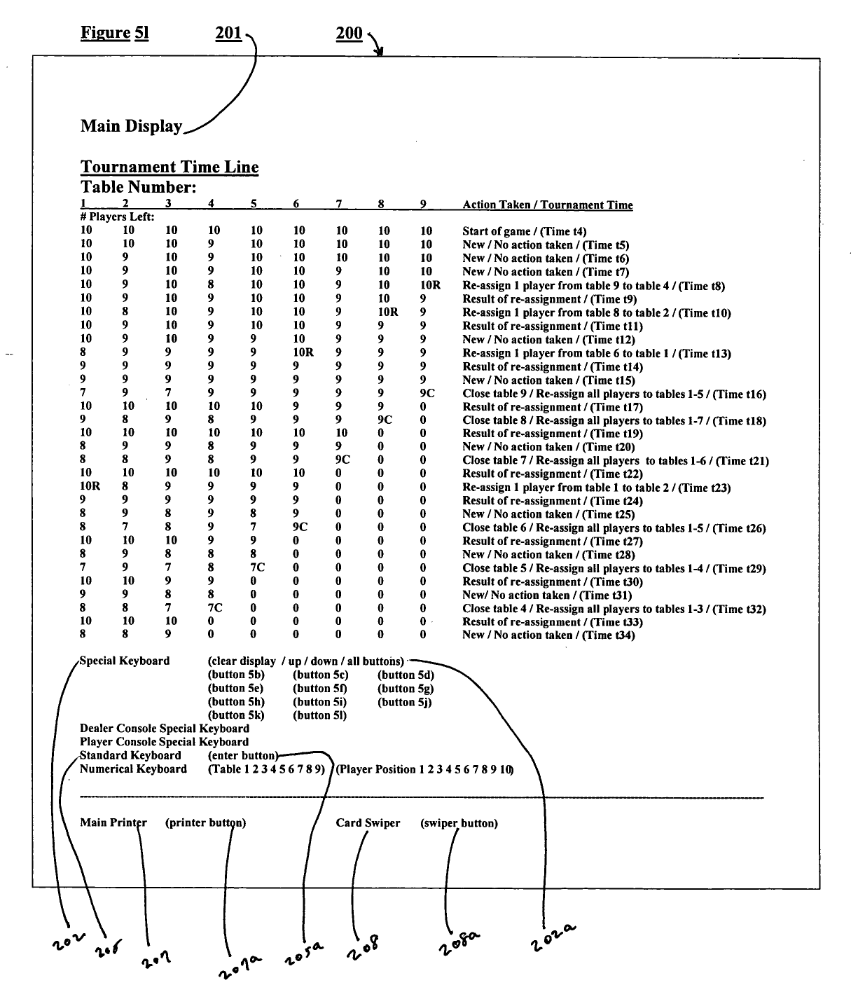

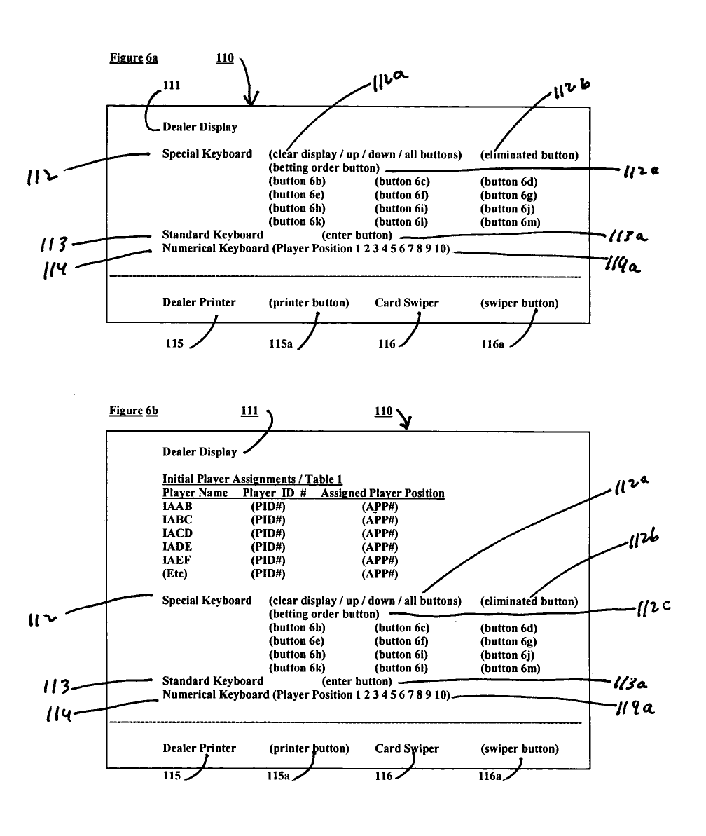

FIGS. 4a-b

FIGS. 4a and 4b respectively show detailed views of main central processing unit CPU 300 and secondary or back-up central processing unit CPU 400 according to the present invention. FIG. 4a shows Main Central Processing Unit CPU 300 including (but not by way of limitation): a Store of Initial Table Assignments/Initial Player Position Assignments; a Store of Table Re-Assignments/Player Position Re-Assignments; a Store of Remaining Players; a Store of Eliminated Players; a Store of Dealer Initial Table Assignments/Dealer Table Re-Assignments; a Store of Tournament Betting Limits/Antes/Blinds; a Store of the Table Replenishment Algorithm, a Store of the Table Re-Filling/Replenishment Algorithm; and a Store of the Table Closure Algorithm. FIG. 4b shows emergency self-powered Secondary Central Processing Unit CPU 400 including (but not by way of limitation) the same stores.

FIGS. 5a-m

FIGS. 5a shows main console MC 200 according to the present invention while FIGS. 5b-m show various touch-responsive screens of main display 201.

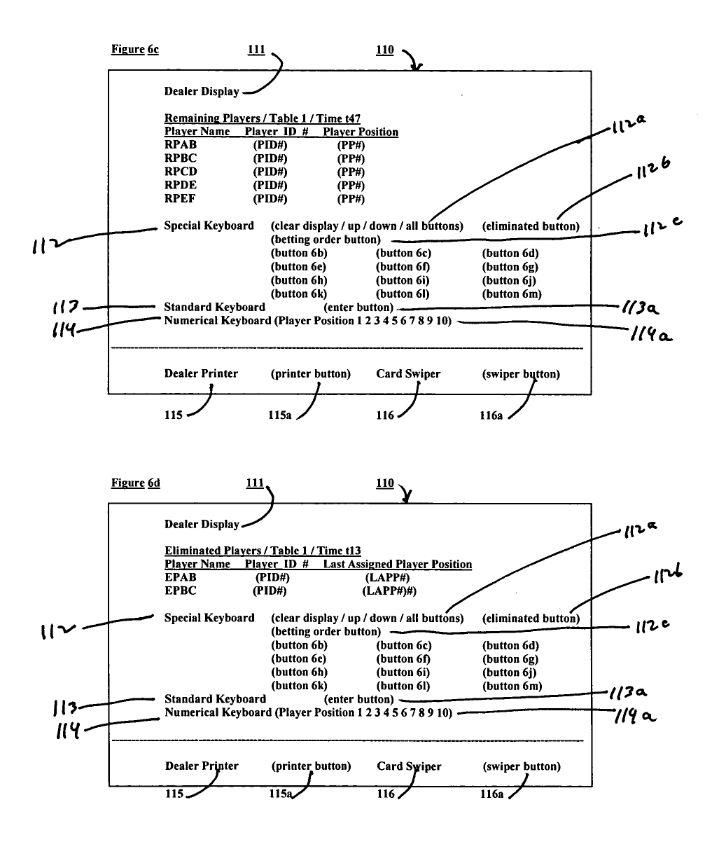

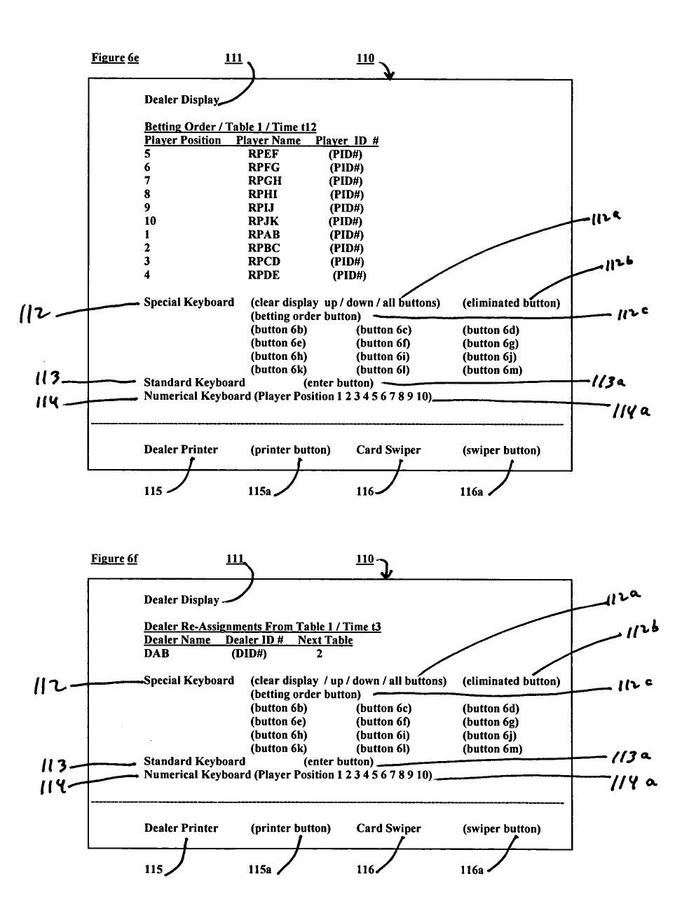

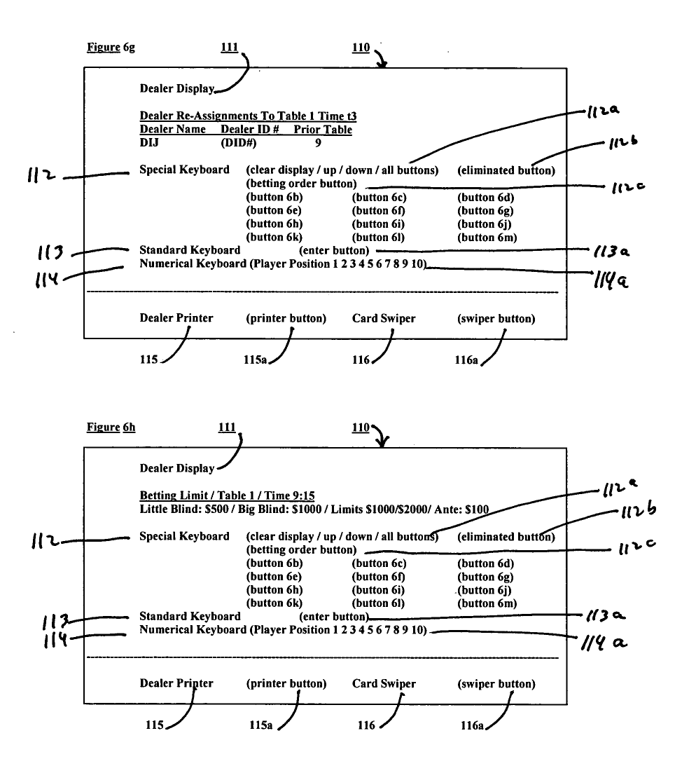

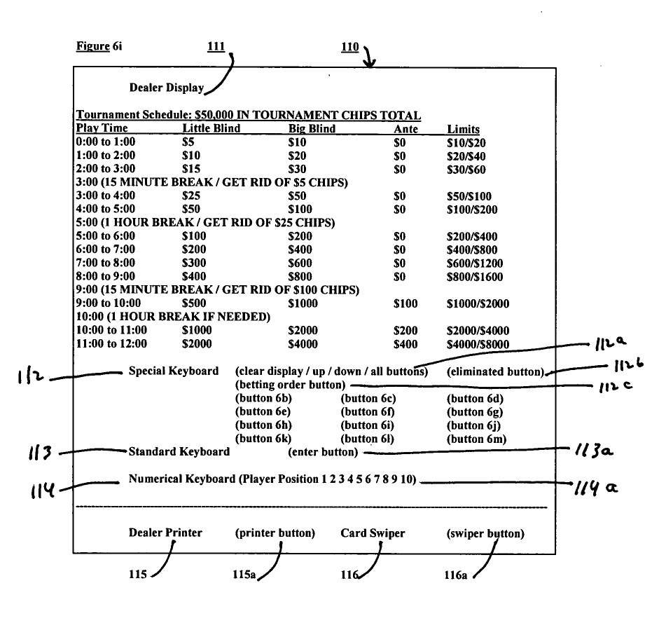

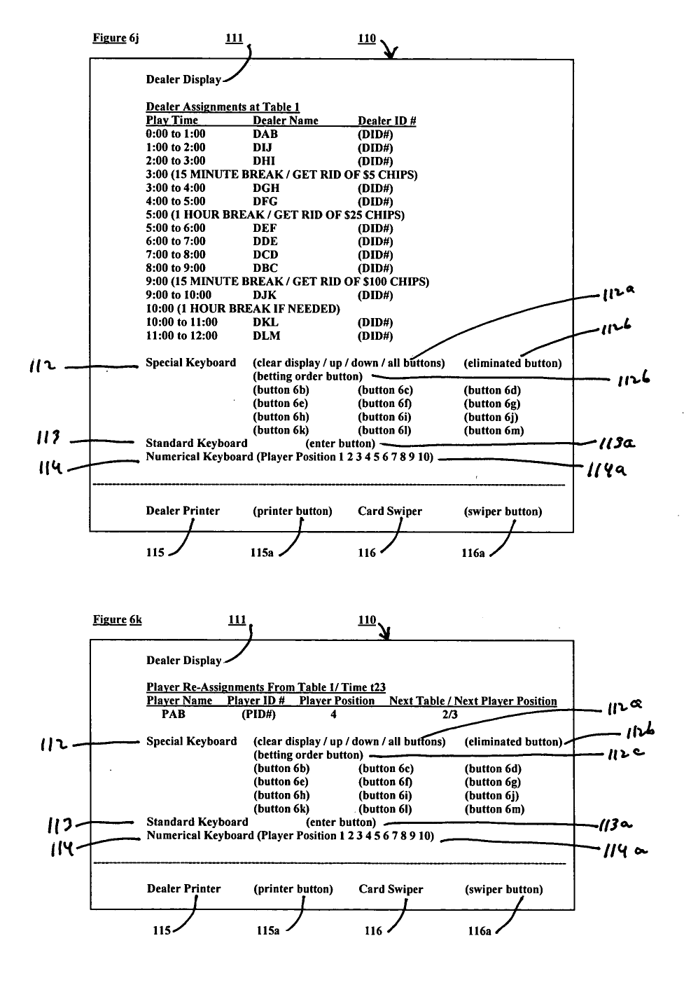

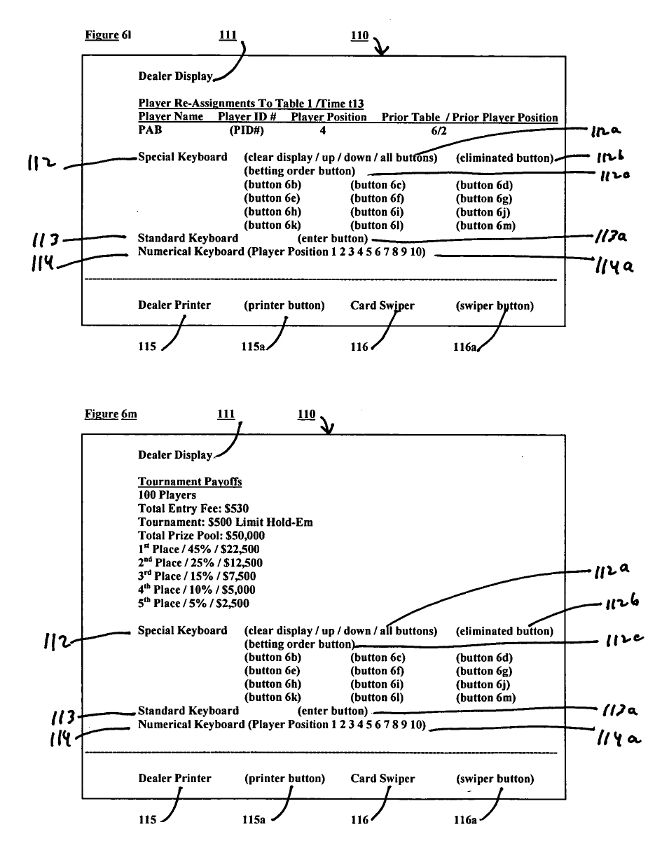

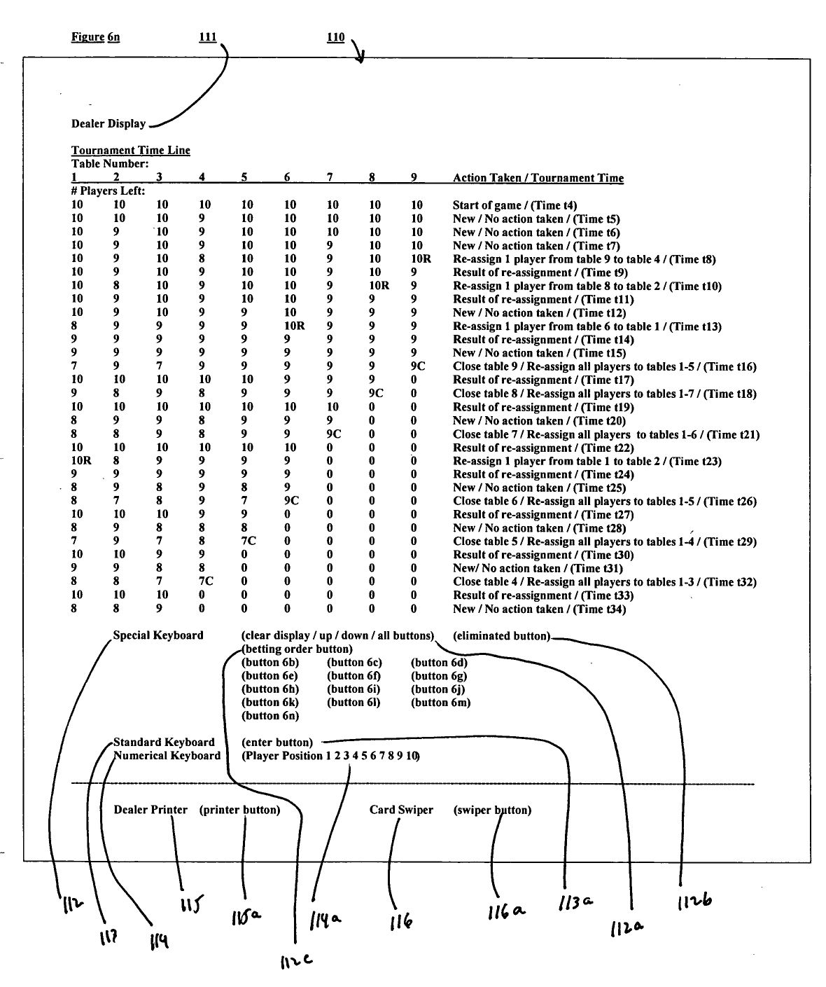

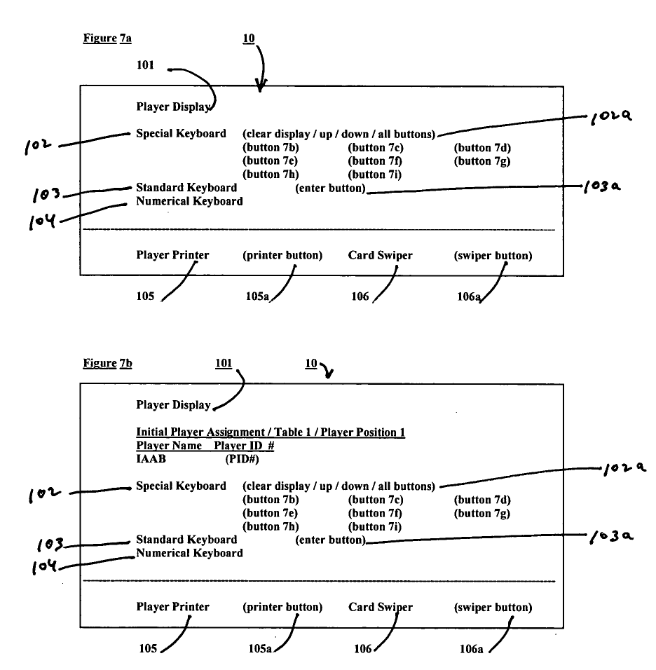

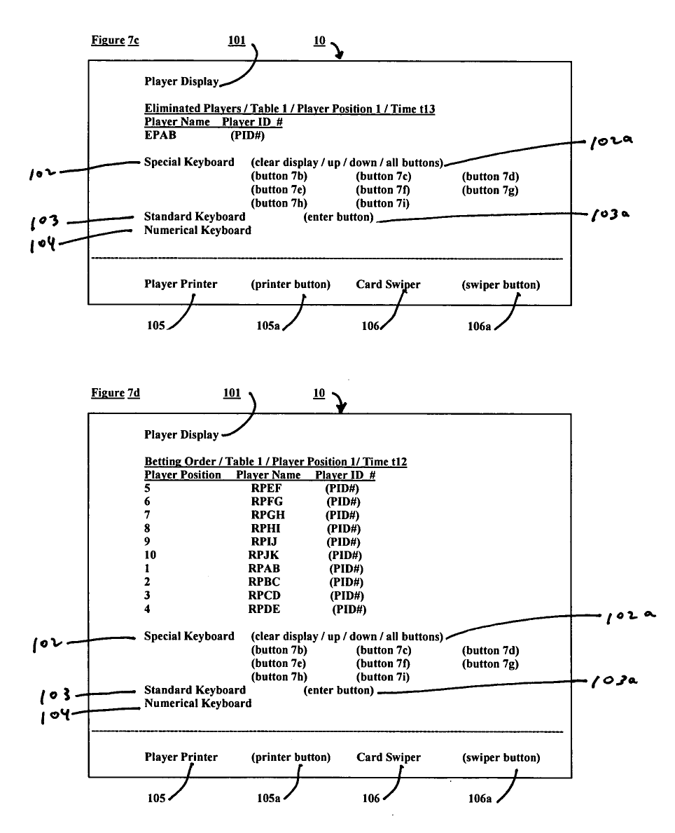

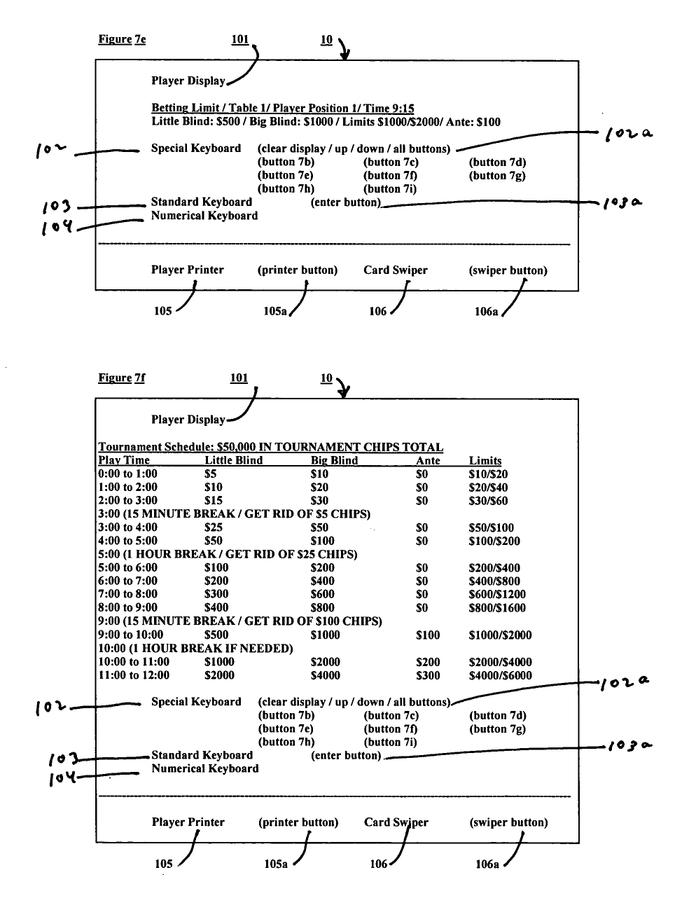

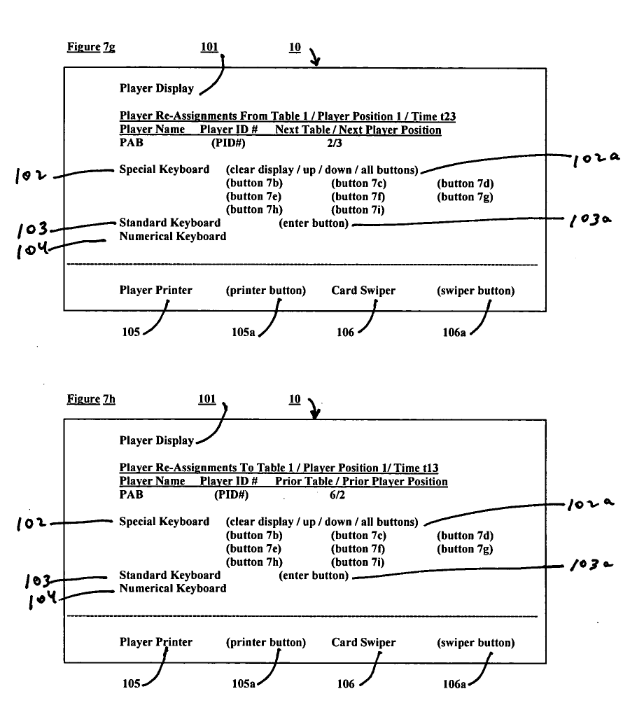

FIG. 5a shows main console MC 200 generally comprising: Main Display 201; Special Keyboard 202; Dealer Console Special Keyboard 203; Player Console Special Keyboard 204; Standard Keyboard 205 with (enter button) 205a; Numerical Keyboard 206 with (Table 1 2 3 4 5 6 7 8 9) buttons 206a and (Player Position 1 2 3 4 5 6 7 8 9 10) buttons 206b; Main Printer 207 with (printer button) 207a; and Card Swiper 208 with (swiper button) 208a. The components of Special Keyboard 202, Dealer Console Special Keyboard 203, Player Console Special Keyboard 204, Standard Keyboard 205, and Numerical Keyboard 206 may be electronically displayed on main display 201 and may be operated as a touch-screen responsive system. Special Keyboard 202 further comprises (clear display/up/down/all buttons) 202a, (button 5b), (button 5c), (button 5d), (button 5e), (button 5f), (button 5g), (button 5h), (button 5i), (button 5j), (button 5k) and (button 5l). Dealer Console Special Keyboard 203 further comprises (button 6b), (button 6c), (button 6d), (button 6e), (button 6f), (button 6g), (button 6h), (button 6i), (button 6j), (button 6k), (button 6l) and (button 6m) of FIGS. 6a-m and may be used by the poker tournament manager to remotely access dealer console display screens as will be hereinafter explained. Player Console Special Keyboard 204 further comprises (button 7b), (button 7c), (button 7d), (button 7e), (button 7f), (button 7g), (button 7h) and (button 7i) of FIGS. 7a-i and may be used by the poker tournament manager to remotely access player console display screens as will be hereinafter explained.

FIG. 5b shows main console MC 200 specifically comprising Main Display 201 displaying an Initial Player Assignment including Player Name, Player ID #, Assigned Table, Assigned Player Position, Total Entry Fee, and Tournament game. Main console MC 200 also comprises Special Keyboard 202 with (button 5b). When a player wants to enter and participate in the poker tournament, the poker tournament manager or his designated main console operator touches (button 5b). The operator then enters the name of the player onto Standard Keyboard 205 or enters the previously assigned casino ID number of the player onto Numerical Keyboard 206. The operator then touches (enter button) 205a on Standard Keyboard 205. In the alternative, the operator may swipe the previously issued casino plastic ID card of the player onto card swiper 208. The operator then presses (swiper button) 208a and then touches (enter button) 205a. Upon (enter button) 205a being touched, a signal is sent to CPU 300 for storing such entered information. CPU 300 then randomly assigns such entering player to an initially assigned poker table and to an initially assigned player position. CPU 300 already has a store therein of the number and numbering of the poker tables and the number and numbering of the player positions at each poker table available to be used in the poker tournament. CPU 300 then sends a signal to main display 201 to display such information known as Initial Player Assignment shown in FIG. 5b. CPU 300 also simultaneously sends a signal to the dealer console display at the assigned poker table such as in FIG. 6b and to the assigned player console display at the assigned poker table such as in FIG. 7b. Usually, the entering player would already have paid his entry fee to the cashier and would now show the entry receipt to the main console operator. To print such displayed information, the operator presses (printer button) 207a of Main Printer 207. To clear such displayed information, the operator presses (clear button) 202a.

FIG. 5c shows main console MC 200 specifically comprising Main Display 201 displaying the Initial Player Assignments list including Player Name, Player ID #, Assigned Table, and Assigned Player Position. Main console MC 200 also comprises Special Keyboard 202 with (button 5c). When the main console operator wants to access and display the names of all entered participants in the poker tournament up to that time, the operator touches (button 5c) and then touches (enter button) 205a on Standard Keyboard 205. This sends a signal to CPU 300 for accessing the stored participant information mentioned above. CPU 300 then sends a signal to main display 201 to display such stored information known as Initial Player Assignments shown in FIG. 5c. CPU 300 also simultaneously sends a signal to the dealer console display at the assigned poker table such as in FIG. 6b and to the assigned player console display at the assigned poker table such as in FIG. 7b. To print such displayed information, the operator presses (printer button) 207a of Main Printer 207. To clear such displayed information, the operator presses (clear button) 202a. It is therefore apparent that CPU 300 generates such Initial Player Assignments list as a result of randomly assigning each entering player to an initial poker table and to an initial player position at such poker table.

FIG. 5d shows main console MC 200 specifically comprising Main Display 201 II displaying the Eliminated Players list including Player Name, Player ID #, Last Assigned Table, and Last Assigned Player Position. Main console MC 200 also comprises Special Keyboard 202 with (button 5d). When the main console operator wants to access and display the Eliminated Players list from the poker tournament up to that time, the operator touches (button 5d) and then touches (enter button) 205a on Standard Keyboard 205. This sends a signal to CPU 300 for accessing such stored information as mentioned hereinafter. CPU 300 then sends a signal to main display 201 to display such stored information known as Eliminated Players shown in FIG. 5d. To print such displayed information, the operator presses (printer button) 207a. To clear main display 201 of such displayed information, the operator presses (clear button) 202a. The Eliminated Players list is generated at the various poker tables by the dealers as will be hereinafter explained with respect to FIG. 6d. When a player at a given poker table loses all his chips, that player is eliminated from the tournament. The dealer at such poker table touches the (eliminated button) on the special keyboard, then the dealer presses the respective (Player Position) button on the numerical keyboard, and then the dealer presses the (enter button) on the standard keyboard. This sends a signal to CPU 300 for storage of such Eliminated Player information. CPU 300 already has stored the player name and player ID # corresponding to such eliminated player. With respect to FIG. 3, when a player loses all his chips and is eliminated from the tournament, such player's player console position is in effect closed or de-activated until another player is re-assigned to such player console position.

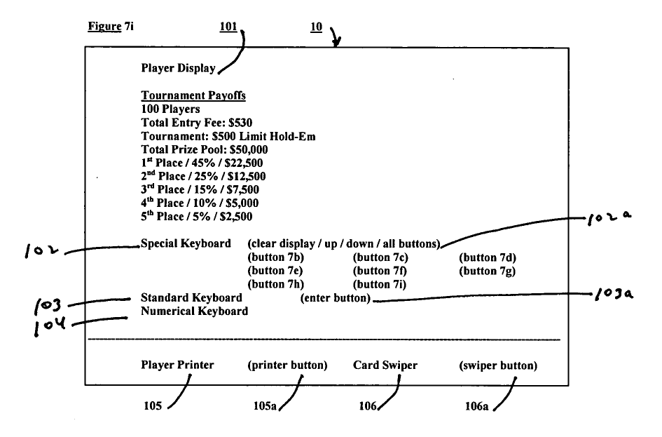

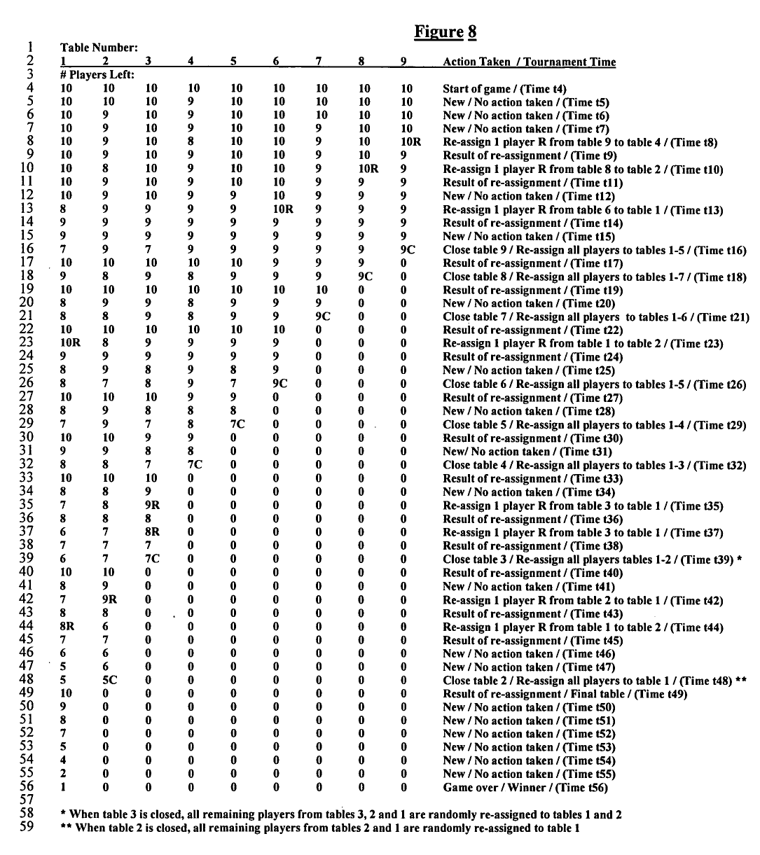

FIG. 5e shows main console MC 200 specifically comprising Main Display 201 displaying the Player Re-Assignments list including Player Name, Player ID#, Present Table, Present Player Position, Prior Table, and Prior Player Position. Main console MC 200 also comprises Special Keyboard 202 with (button 5e). When the main console operator wants to access and display the Player Re-Assignments list up to that time, the operator touches (button 5e) and then touches (enter button) 205a on Standard Keyboard 205. This sends a signal to CPU 300 for accessing such stored information as mentioned hereinafter. CPU 300 then sends a signal to main display 201 to display such stored information known as Player Re-Assignments shown in FIG. 5e. To print such displayed information, the operator presses (printer button) 207a. To clear main display 201 of such displayed information, the operator presses (clear button) 202a. Players are re-assigned from a donor poker table to a donee poker table in accordance with the pre-stored algorithms hereinafter explained in relation to FIG. 8.

FIG. 5f shows main console MC 200 specifically comprising Main Display 201 displaying the Remaining Players list including Player Name, Player ID #, Table, and Player Position. Main console MC 200 also comprises Special Keyboard 202 with (button 5f). When the main console operator wants to access and display the Remaining Players list in the poker tournament up to that time, the operator touches (button 5f) and then touches (enter button) 205a on Standard Keyboard 205. This sends a signal to CPU 300 for accessing such stored information as mentioned hereinafter. CPU 300 then sends a signal to Main Display 201 to display such stored information known as Remaining Players shown in FIG. 5f. To print such displayed information, the operator presses (printer button) 207a. To clear Main Display 201 of such displayed information, the operator presses (clear button) 202a. CPU 300 constructs the Remaining Player list from the following information: the stored initial player assignment list; the stored player re-assignment list; and the stored Eliminated Player list. The number of players remaining at a given poker table at a given time is equal to the number of initially assigned players to that given poker table plus the number of players re-assigned from donor poker tables to that given poker table, minus the number of players eliminated from that given poker table minus the number of players re-assigned from that given poker table to donee poker tables.

FIG. 5g shows main console MC 200 specifically comprising Main Display 201 displaying the Tournament Schedule including TOURNAMENT CHIP TOTAL, Play Time, Little Blind, Big Blind, Ante, Limits, BREAK time, CHIP change. Main console MC 200 also comprises Special Keyboard 202 with (button 5g). Small denomination chips are converted to larger denomination chips as the poker tournament progresses because the betting limits increase at pre-determined time periods thereby obviating the use of small denomination chips to make larger and larger bets. When the main console operator wants to access and display the Poker Tournament schedule, the operator touches (button 5g) and then touches (enter button) 205a on Standard Keyboard 205. This sends a signal to CPU 300 for accessing such pre-stored tournament schedule. CPU 300 then sends a signal to main display 201 to display such pre-stored information known as Tournament Schedule shown in FIG. 5g. To print such displayed information, the operator presses (printer button) 207a. To clear main display 201 of such displayed information, the operator presses (clear button) 202a.

According to the present invention, there are two types of information stored in CPU 300. The first type of stored information relates to information which is stored in CPU 300 before actual tournament play begins and includes: Store of pre-numbered poker tables and store of pre-numbered player positions at each poker table; Store of Initial Table Assignments/Initial Player Position Assignments; Store of Dealer Initial Table Assignments/Dealer Table Re-Assignments; Store of Tournament Schedule/Betting Limits/Antes; Store of Tournament Payoff schedule; Store of the Table Replenishment Algorithm; Store of the Table Re-Filling/Table Replenishment Algorithm; and Store of the Table Closure Algorithm. The second type of stored information relates to dynamic information which is generated while tournament play is in progress and includes: Store of Table Re-Assignments/Player Position Re-Assignments; Store of Remaining Players; and Store of Eliminated Players.

FIG. 5h shows main console MC 200 specifically comprising Main Display 201 displaying the Dealer Initial Poker Table Assignment/Dealer Poker Table Re-Assignments schedule including Dealer Name, Dealer ID#, Initial Poker Table Assignment/Poker Table Re-Assignments, and dealer BREAK times. Main console MC 200 also comprises Special Keyboard 202 with (button 5h). When the main console operator wants to access and display the Dealer Initial Poker Table Assignment/Dealer Poker Table Re-Assignments schedule, the operator touches (button 5h) and then touches (enter button) 205a on Standard Keyboard 205. This sends a signal to CPU 300 for accessing such pre-stored information. CPU 300 then sends a signal to main display 201 to display such pre-stored information known as Dealer Initial Poker Table Assignment/Dealer Poker Table Re-Assignments shown FIG. 5h. To print such displayed information, the operator presses (printer button) 207a. To clear main display 201 of such displayed information, the operator presses (clear button) 202a.

FIG. 5i shows main console MC 200 specifically comprising Main Display 201 displaying the Tournament Payoff schedule including number of Players, Total Entry Fee, Tournament description, Total Prize Pool, and place payoffs. Main console MC 200 also comprises Special Keyboard 202 with (button 5i). When the main console operator wants to access and display the Tournament Payoff schedule, the operator touches (button 5i) and then touches (enter button) 205a on Standard Keyboard 205. This sends a signal to CPU 300 for accessing such pre-stored information. CPU 300 then sends a signal to main display 201 to display such pre-stored information known as Tournament Payoff shown FIG. 5i. To print such displayed information, the operator presses (printer button) 207a. To clear main display 201 of such displayed information, the operator presses (clear button) 202a.

FIG. 5j shows main console MC 200 specifically comprising Main Display 201 displaying the Table Closures list including number of Table closed and Time Closed. Main console MC 200 also comprises Special Keyboard 202 with (button 5j). When the main console operator wants to access and display the Table Closures list up to that time, the operator touches (button 5j) and then touches (enter button) 205a on Standard Keyboard 205. This sends a signal to CPU 300 for accessing such stored information. CPU 300 then sends a signal to main display 201 to display such stored information known as Table Closures shown FIG. 5j. To print such displayed information, the operator presses (printer button) 207a. To clear main display 201 of such displayed information, the operator presses (clear button) 202a. The Table Closure list is generated by CPU 300 during actual play of the poker tournament in accordance with the pre-stored table closure algorithm hereinafter explained in relation to FIG. 8.

FIG. 5k shows main console MC 200 specifically comprising Main Display 201 displaying the Betting Limits. Main console MC 200 also comprises Special Keyboard 202 with (button 5k). When the main console operator wants to access and display the Betting Limits at that time, the operator touches (button 5k) and then touches (enter button) 205a on Standard Keyboard 205. This sends a signal to CPU 300 for accessing such stored information. CPU 300 then sends a signal to main display 201 to display such stored information known as Betting Limits list shown FIG. 5k. To print such displayed information, the operator presses (printer button) 207a. To clear main display 201 of such displayed information, the operator presses (clear button) 202a.

FIG. 5l shows main console MC 200 specifically comprising Main Display 201 displaying the Tournament Time line list. Main console MC 200 also comprises Special Keyboard 202 with (button 5l). When the main console operator wants to access and display the Tournament Time line, the operator touches (button 5l) and then touches (enter button) 205a on Standard Keyboard 205. This sends a signal to CPU 300 for accessing such stored information. CPU 300 then sends a signal to main display 201 to display such stored information known as Tournament Time line list shown FIG. 5l. To print such displayed information, the operator presses (printer button) 207a. To clear main display 201 of such displayed information, the operator presses (clear button) 202a.

FIG. 5m shows main console MC 200 specifically comprising Main Display 201 displaying both the Table Closures list and the Tournament Payoff schedule as respectively described above in relation to FIGS. 5j and 5i. If the main console operator wants to access and display the Table Closures list, the operator touches (button 5j) and then touches (enter button) 205a on Standard Keyboard 205. If the main console operator also wants to access and display the Tournament Payoff schedule, the operator touches (button 5i) and then touches (enter button) 205a on Standard Keyboard 205. To print such displayed combined information, the operator presses (printer button) 207a. To clear main display 201 of such combined displayed information, the operator presses (all clear button) 202a. To clear main display 201 only of the Table Closures list, the operator presses (up clear button) 202a. To clear main display 201 only of the Tournament Payoff schedule, the operator presses (down clear button) 202a.

FIGS. 6a-m

FIG. 6a shows dealer console DC 110 according to the present invention while FIGS. 6b-m show various touch-responsive screens of dealer display 111. FIG. 6a shows dealer console DC 110 generally comprising Dealer display 111; Special keyboard 112; Standard keyboard 113 with (enter button) 113a; Numerical keyboard 114 with (Player Position 1 2 3 4 5 6 7 8 9 10) button 114a; Dealer printer 115 with (printer button) 115a; and Card swiper 116 with (swiper button) 116a. Special keyboard 112 further comprises (clear display/up/down/all buttons) 112a, (eliminated button) 112b, (betting order button) 112c, (button 6b), (button 6c), (button 6d), (button 6e), (button 6f), (button 6g), (button 6h), (button 6i), (button 6j), (button 6k), (button 6l) and (button 6m). The components of Special keyboard 112, Standard keyboard 113 and Numerical keyboard 114 may be electronically displayed on dealer display 111 and may be operated as a touch-screen responsive system.

FIG. 6b shows dealer console DC 110 specifically comprising Dealer display 111 displaying the list of those entering players initially randomly assigned to Table 1 called the Initial Player Assignments at Table 1 list including Player Name, Player ID #, and Assigned Player Position. Dealer console DC 110 also comprises Special keyboard 112 with (button 6b). When the dealer or the poker tournament manager want to access and display the Initial Player Assignments at Table 1 list, the dealer touches (button 6b) and then touches (enter button) 113a on Standard Keyboard 113. This sends a signal to CPU 300 for accessing such stored information. CPU 300 then sends a signal to dealer display 111 to display such stored information known as Initial Player Assignments at Table 1 shown in FIG. 6b. To print such displayed information, the operator presses (printer button) 115a. To clear dealer display 111 of such displayed information, the dealer presses (clear button) 112a.

FIG. 6c shows dealer console DC 110 specifically comprising Dealer display 111 displaying the Remaining Players at Table 1 list including Player Name, Player ID #, and Player Position. Dealer console DC 110 also comprises Special keyboard 112 with (button 6c). When the dealer or the poker tournament manager wants to access and display the Remaining Players at Table 1 list at that time, the dealer touches (button 6c) and then touches (enter button) 113a on Standard Keyboard 113. This sends a signal to CPU 300 for accessing such stored information. CPU 300 then sends a signal to dealer display 111 to display such stored information known as Remaining Players at Table 1 shown in FIG. 6c. To print such displayed information, the operator presses (printer button) 115a. To clear dealer display 111 of such displayed information, the dealer presses (clear button) 112a.

FIG. 6d shows dealer console DC 110 specifically comprising Dealer display 111 displaying the Eliminated Players at Table 1 list including Player Name, Player ID # and Last Assigned Player Position. Dealer console DC 110 also comprises Special keyboard 112 with (button 6d). When the dealer or the poker tournament manager wants to access and display the Eliminated Players at Table 1 list up to that time, the dealer touches (button 6d) and then touches (enter button) 113a on Standard Keyboard 113. This sends a signal to CPU 300 for accessing such stored information. CPU 300 then sends a signal to dealer display 111 to display such stored information known as Eliminated Players at Table 1 shown in FIG. 6d. To print such displayed information, the operator presses (printer button) 115a. To clear dealer display 111 of such displayed information, the dealer presses (clear button) 112a. The Eliminated Players list is generated at the various poker tables by the dealers during actual play. When a player at a given poker table loses all his chips, that player is eliminated from the tournament. For example, the dealer at Table 1 touches (eliminated button) 112b on special keyboard 112, then the dealer presses the respective (Player Position 1 2 3 4 5 6 7 8 9 10) button 114a on numerical keyboard 114, and then the dealer presses (enter button) 113a on standard keyboard 113. This sends a signal to CPU 300 for storage of such Eliminated Player information and for display. CPU 300 already has stored the player name and player ID # corresponding to such eliminated player.

FIG. 6e shows dealer console DC 110 specifically comprising Dealer display 111 displaying the Betting Order at Table 1 list including Player Position, Player Name, and Player ID #. Dealer console DC 110 also comprises Special keyboard 112 with (button 6e). When the dealer or the poker tournament manager wants to access and display the Betting Order at Table 1 list during the poker hand, the dealer touches (button 6e) and then touches (enter button) 113a on Standard Keyboard 113. This sends a signal to CPU 300 for accessing such stored information. CPU 300 then sends a signal to dealer display 111 to display such stored information known as Betting Order at Table 1 shown in FIG. 6e. To print such displayed information, the operator presses (printer button) 115a. To clear dealer display 111 of such displayed information, the dealer presses (clear button) 112a. The Betting Order list at a given poker table is generated by the dealer during actual play. When one poker hand ends and another poker hand is to begin, the dealer designates the betting order for the next hand. For example, the dealer at Table 1 touches (betting order) button 112c on special keyboard 112, then the dealer presses the respective (Player Position 1 2 3 4 5 6 7 8 9 10) button 114a on numerical keyboard 114, and then the dealer presses (enter button) 113a on standard keyboard 113. This sends a signal to CPU 300 for storage of such Betting Order list for such poker table and for display.

FIG. 6f shows dealer console DC 110 specifically comprising Dealer display 111 displaying the Dealer Re-Assignments From Table 1 list including Dealer Name, Dealer ID #, and Next Table. Dealer console DC 110 also comprises Special keyboard 112 with (button 6f). When the dealer or the poker tournament manager wants to access and display the Dealer Re-Assignments From Table 1 list up to that time, the dealer touches (button 6f) and then touches (enter button) 113a on Standard Keyboard 113. This sends a signal to CPU 300 for accessing such stored information. CPU 300 then sends a signal to dealer display 111 to display such stored information known as Dealer Re-Assignments From Table 1 shown in FIG. 6f. To print such displayed information, the operator presses (printer button) 115a. To clear dealer display 111 of such displayed information, the dealer presses (clear button) 112a.

FIG. 6g shows dealer console DC 110 specifically comprising Dealer display 111 displaying the Dealer Re-Assignments To Table 1 list including Dealer Name, Dealer ID #, and Prior Table. Dealer console DC 110 also comprises Special keyboard 112 with (button 6g). When the dealer or the poker tournament manager wants to access and display the Dealer Re-Assignments To Table 1 list up to that time, the dealer touches (button 6g) and then touches (enter button) 113a on Standard Keyboard 113. This sends a signal to CPU 300 for accessing such stored information. CPU 300 then sends a signal to dealer display 111 to display such stored information known as Dealer Re-Assignments To Table 1 shown in FIG. 6g. To print such displayed information, the operator presses (printer button) 115a. To clear dealer display 111 of such displayed information, the dealer presses (clear button) 112a.

FIG. 6h shows dealer console DC 110 specifically comprising Dealer display 111 displaying the Betting Limit at Table 1 including the Little Blind, the Big Blind, the Limits, the Ante, and the Time. Dealer console DC 110 also comprises Special keyboard 112 with (button 6h). When the dealer or the poker tournament manager wants to access and display the Betting Limit at Table 1 at that time, the dealer touches (button 6h) and then touches (enter button) 113a on Standard Keyboard 113. This sends a signal to CPU 300 for accessing such pre-stored information. CPU 300 then sends a signal to dealer display 111 to display such pre-stored information known as Betting Limit at Table 1 shown in FIG. 6h. To print such displayed information, the operator presses (printer button) 115a. To clear dealer display 111 of such displayed information, the dealer presses (clear button) 112a.

FIG. 6i shows dealer console DC 110 specifically comprising Dealer display 111 displaying the Tournament Schedule including total TOURNAMENT CHIPS, Play Time, the Little Blind, the Big Blind, the Antes, the Limits, the BREAKS, and the CHIP changes. Dealer console DC 110 also comprises Special keyboard 112 with (button 6i). When the dealer or the poker tournament manager wants to access and display the Tournament Schedule, the dealer touches (button 6i) and then touches (enter button) 113a on Standard Keyboard 113. This sends a signal to CPU 300 for accessing such pre-stored information. CPU 300 then sends a signal to dealer display 111 to display such pre-stored information known as Tournament Schedule shown in FIG. 6i. To print such displayed information, the operator presses (printer button) 115a. To clear dealer display 111 of such displayed information, the dealer presses (clear button) 112a.

FIG. 6j shows dealer console DC 110 specifically comprising Dealer display 111 displaying the Dealer Assignments at Table 1 list including Play Time, Dealer Name, and Dealer ID #. Dealer console DC 110 also comprises Special keyboard 112 with (button 6j). When the dealer or the poker tournament manager wants to access and display the Dealer Assignments at Table 1 list up to that time, the dealer touches (button 6j) and then touches (enter button) 113a on Standard Keyboard 113. This sends a signal to CPU 300 for accessing such stored information. CPU 300 then sends a signal to dealer display 111 to display such stored information known as Dealer Assignments at Table 1 shown in FIG. 6j. To print such displayed information, the operator presses (printer button) 115a. To clear dealer display 111 of such displayed information, the dealer presses (clear button) 112a.

FIG. 6k shows dealer console DC 110 specifically comprising Dealer display 111 displaying the Player Re-Assignments From Table 1 list including Player Name, Player ID #, Player Position, Next Table, and Next Player Position. Dealer console DC 110 also comprises Special keyboard 112 with (button 6k). When the dealer or the poker tournament manager wants to access and display the Player Re-Assignments From Table 1 list up to that time, the dealer touches (button 6k) and then touches (enter button) 113a on Standard Keyboard 113. This sends a signal to CPU 300 for accessing such stored information. CPU 300 then sends a signal to dealer display 111 to display such stored information known as Player Re-Assignments From Table 1 shown in FIG. 6k. To print such displayed information, the operator presses (printer button) 115a. To clear dealer display 111 of such displayed information, the dealer presses (clear button) 112a. The Player Re-Assignments From Table 1 list is generated by CPU 300 in accordance with the pre-stored algorithms hereinafter explained in relation to FIG. 8.

FIG. 6l shows dealer console DC 110 specifically comprising Dealer display 111 displaying the Player Re-Assignments To Table 1 list including Player Name, Player ID #, Player Position, Prior Table, and Prior Player Position. Dealer console DC 110 also comprises Special keyboard 112 with (button 6l). When the dealer or the poker tournament manager wants to access and display the Player Re-Assignments To Table 1 list up to that time, the dealer touches (button 6l) and then touches (enter button) 113a on Standard Keyboard 113. This sends a signal to CPU 300 for accessing such stored information. CPU 300 then sends a signal to dealer display 111 to display such stored information known as Player Re-Assignments To Table 1 shown in FIG. 6l. To print such displayed information, the operator presses (printer button) 115a. To clear dealer display 111 of such displayed information, the dealer presses (clear button) 112a. The Player Re-Assignments To Table 1 list is generated by CPU 300 in accordance with the pre-stored algorithms hereinafter explained in relation to FIG. 8.

FIG. 6m shows dealer console DC 110 specifically comprising Dealer display 111 displaying the Tournament Payoff schedule including the number of entries, the Total Entry Fee, the Tournament game, the and Total Prize Pool. Dealer console DC 110 also comprises Special keyboard 112 with (button 6m). When the dealer or the poker tournament manager wants to access and display the Tournament Payoff schedule, the dealer touches (button 6m) and then touches (enter button) 113a on Standard Keyboard 113. This sends a signal to CPU 300 for accessing such pre-stored information. CPU 300 then sends a signal to dealer display 111 to display such pre-stored information known as Tournament Payoff schedule shown in FIG. 6m. To print such displayed information, the operator presses (printer button) 115a. To clear dealer display 111 of such displayed information, the dealer presses (clear button) 112a.

FIG. 6n shows the tournament time line display according to the present invention at touch-responsive display screen 111 of dealer console DC 110. Such time line display will be explained in detail hereinafter.

FIGS. 7a-i

FIG. 7a shows player console PC 10 according to the present invention while FIGS. 7b-i show various touch-responsive screens of player display 101.

FIG. 7a shows player console PC 10 generally comprising Player display 101, Special keyboard 102, Standard keyboard 103 with (enter button) 103a, Numerical keyboard 104, Player printer 105 with (printer button) 105a, and Card swiper 106 with (swiper button) 106a. Special keyboard 102 further comprises (clear display/up/down/all buttons) 102a, (button 7b), (button 7c), (button 7d), (button 7e), (button 7f), (button 7g), (button 7h) and (button 7i). The components of Special keyboard 102, Standard keyboard 103 and Numerical keyboard 104 may be electronically displayed on player display 101 and may be operated as a touch-screen responsive system.

FIG. 7b shows player console PC 10 specifically comprising Player display 101 displaying the Initial Player Assignment at Table 1/Player Position 1 including Player Name and Player ID #. Player console PC 10 also comprises Special keyboard 102 with (button 7b). When the poker tournament manager (only) wants to access and display the Initial Player Assignment at Table 1/Player Position 1, the manager (only) touches (button 7b) and then touches (enter button) 103a on Standard Keyboard 103. This sends a signal to CPU 300 for accessing such stored information. CPU 300 then sends a signal to player display 101 to display such stored information known as Initial Player Assignment at Table 1/Player Position 1 shown in FIG. 7b. To print such displayed information, the manager (only) presses (printer button) 105a. To clear player display 101 of such displayed information, the manager (only) presses (clear button) 102b. CPU 300 generates such Initial Player Assignment at Table 1/Player Position 1 as a result of randomly assigning an entering player to such initial poker table and to such initial player position.

FIG. 7c shows player console PC 10 specifically comprising Player display 101 displaying the Eliminated Players at Table 1/Player Position 1 list including Player Name and Player ID #. Player console PC 10 also comprises Special keyboard 102 with (button 7c). When the poker tournament manager (only) wants to access and display the Eliminated Players at Table 1/Player Position 1 list up to that time, the manager (only) touches (button 7c) and then touches (enter button) 103a on Standard Keyboard 103. This sends a signal to CPU 300 for accessing such stored information. CPU 300 then sends a signal to player display 101 to display such stored information known as Eliminated Players at Table 1/Player Position 1 shown in FIG. 7c. To print such displayed information, the manager (only) presses (printer button) 105a. To clear player display 101 of such displayed information, the manager (only) presses (clear button) 102b. The Eliminated Players list is generated at the various poker tables by the dealers during actual play. When a player at a given poker table loses all his chips, that player is eliminated from the tournament. For example, the dealer at Table 1 touches (eliminated button) 112b on special keyboard 112, then the dealer presses the respective (Player Position 1 2 3 4 5 6 7 8 9 10) button 114a on numerical keyboard 114, and then the dealer presses (enter button) 113a on standard keyboard 113. This sends a signal to CPU 300 for storage of such Eliminated Player information and for display. CPU 300 already has stored the player name and player ID # corresponding to such eliminated player.

FIG. 7d shows player console PC 10 specifically comprising Player display 101 displaying the Betting Order at Table 1 including Player Position, Player Name, and Player ID #. Player console PC 10 also comprises Special keyboard 102 with (button 7d). When the player wants to access and display the Betting Order at Table 1 during that poker hand, the player touches (button 7d) and then touches (enter button) 103a on Standard Keyboard 103. This sends a signal to CPU 300 for accessing such stored information. CPU 300 then sends a signal to player display 101 to display such stored information known as Betting Order at Table 1 shown in FIG. 7d. To print such displayed information, the player presses (printer button) 105a. To clear player display 101 of such displayed information, the player presses (clear button) 102b. The Betting Order list is generated at a given poker table by the dealer during actual play. When one poker hand ends and another poker hand is to begin, the dealer designates the betting order for the next hand. For example, the dealer at Table 1 touches (betting order) button 112c on special keyboard 112, then the dealer presses the respective (Player Position 1 2 3 4 5 6 7 8 9 10) button 114a on numerical keyboard 114, and then the dealer presses (enter button) 113a on standard keyboard 113. This sends a signal to CPU 300 for storage of such Betting Order list for Table 1 and for display.

FIG. 7e shows player console PC 10 specifically comprising Player display 101 displaying the Betting Limit at Table 1 including the Little Blind, the Big Blind, the Limits, the Antes and the Time. Player console PC 10 also comprises Special keyboard 102 with (button 7e). When the player wants to access and display the Betting Limit at Table 1 at that time, the player touches (button 7e) and then touches (enter button) 103a on Standard Keyboard 103. This sends a signal to CPU 300 for accessing such pre-stored information. CPU 300 then sends a signal to player display 101 to display such pre-stored information known as Betting Limit at Table 1 shown in FIG. 7e. To print such displayed information, the player presses (printer button) 105a. To clear player display 101 of such displayed information, the player presses (clear button) 102b.

FIG. 7f shows player console PC 10 specifically comprising Player display 101 displaying the Tournament Schedule including total TOURNAMENT CHIP count, Play Time, the Little Blind, the Big Blind, the Ante, the Limits, the BREAKS, and the CHIP changes. Player console PC 10 also comprises Special keyboard 102 with (button 7f). When the player wants to access and display the Tournament Schedule, the player touches (button 7f) and then touches (enter button) 103a on Standard Keyboard 103. This sends a signal to CPU 300 for accessing such pre-stored information. CPU 300 then sends a signal to player display 101 to display such pre-stored information known as Tournament Schedule shown in FIG. 7f. To print such displayed information, the player presses (printer button) 105a. To clear player display 101 of such displayed information, the player presses (clear button) 102b.

FIG. 7g shows player console PC 10 specifically comprising Player display 101 displaying the Player Re-Assignments From Table 1/Player Position 1 list including Player Name, Player ID #, Next Table, and Next Player Position. Player console PC 10 also comprises Special keyboard 102 with (button 7g). When the poker tournament manager (only) wants to access the Player Re-Assignments From Table 1/Player Position 1 list up to that time, the manager (only) touches (button 7g) and then touches (enter button) 103a on Standard Keyboard 103. This sends a signal to CPU 300 for accessing such stored information. CPU 300 then sends a signal to player display 101 to display such stored information known as Player Re-Assignments From Table 1/Player Position 1 shown in FIG. 7g. To print such displayed information, the manager (only) presses (printer button) 105a. To clear player display 101 of such displayed information, the manager (only) presses (clear button) 102b. The Player Re-Assignments From Table 1/Player Position 1 list is generated by CPU 300 in accordance with the pre-stored algorithms hereinafter explained in relation to FIG. 8.

FIG. 7h shows player console PC 10 specifically comprising Player display 101 displaying the Player Re-Assignments To Table 1/Player Position 1 list including Player Name, Player ID #, Prior Table, and Prior Player Position. Player console PC 10 also comprises Special keyboard 102 with (button 7h). When the poker tournament manager (only) wants to access and display the Player Re-Assignments To Table 1/Player Position 1 list up to that time, the manager (only) touches (button 7h) and then touches (enter button) 103a on Standard Keyboard 103. This sends a signal to CPU 300 for accessing such stored information. CPU 300 then sends a signal to player display 101 to display such stored information known as Player Re-Assignments To Table 1/Player Position 1 shown in FIG. 7h. To print such displayed information, the manager (only) presses (printer button) 105a. To clear player display 101 of such displayed information, the manager (only) presses (clear button) 102b. The Player Re-Assignments To Table 1/Player Position 1 list is generated by CPU 300 in accordance with the pre-stored algorithms hereinafter explained in relation to FIG. 8.

FIG. 7i shows player console PC 10 specifically comprising Player display 101 displaying the Tournament Payoff schedule including the number of entries, the Total Entry Fee, the Tournament game, and the payoff schedule by place. Player console PC 10 also comprises Special keyboard 102 with (button 7i). When the player wants to access and display the Tournament Payoff schedule, the player touches (button 7i) and then touches (enter button) 103a on Standard Keyboard 103. This sends a signal to CPU 300 for accessing such pre-stored information. CPU 300 then sends a signal to player display 101 to display such pre-stored information known as Tournament Payoff shown in FIG. 7i. To print such displayed information, the player presses (printer button) 105a. To clear player display 101 of such displayed information, the player presses (clear button) 102b.

According to the present invention, the replenishment of a donee poker table by a donor poker table by way of re-assignment of one randomly chosen player from the donor table to the donee table is controlled by the following table replenishment algorithm. If the poker table with the most remaining players has only one player more than the poker table with the least remaining players, then CPU 300 does not re-assign a player from the most populated poker table to the least populated poker table. For example, let is be assumed that each poker table has either 10 or 9 remaining players, or that each poker table has either 9 or 8 remaining players. In such cases the table replenishment algorithm does not come into play and CPU 300 takes no action. On the other hand, if the poker table with the most remaining players has two players more than the poker table with the least remaining players, then CPU 300 re-assigns one player from the most populated poker table (the donor table) to the least populated poker table (the donee table) to replenish such least populated poker table. For example, let it be assumed that the most populated poker table has 10 remaining players while the least populated poker table has 8 remaining players, or that the most populated poker table has 9 remaining players while the least populated poker table has 7 remaining players. In such cases, CPU 300 randomly chooses one of the remaining players from the most populated poker table (the donor table) and then re-assigns such chosen player to replenish the least populated table (the donee table) without closing a table. If two tables each have the most remaining players and two tables each have the least remaining players, then the most populated table numbered higher gives up one player to the least populated table numbered lower, while the most populated table numbered lower gives up one player to the least populated table numbered higher. In other words, donor tables are preferably chosen from the higher numbered tables and donee tables are preferably chosen from the lower numbered tables. This is not an academic exercise because the specific players re-assigned from the most populated tables to the least populated tables are different players based on such random choosing and re-assignment of such players from the higher numbered most populated donor table to the lower numbered least populated donee table. For example, let it be assumed that the poker tournament started with a total of T poker tables being numbered T(1) to T(T). Let it be further assumed that the poker table numbered 1 is designated to be the “final” table where the tournament champion will to determined. Therefore, if poker tables numbered 9 and 7 each have the most remaining players, and if poker tables numbered 1 and 3 each have the least remaining players, then table 9 donates one randomly chosen player to table 1, while table 7 donates one randomly chosen player to table 3. In the examples cited herein, the poker tournament started with 9 tables thereby making T=9.

According to the present invention, the re-filling or replenishment of at least one donee table by a donor table by way of re-assignment of all the remaining randomly chosen players from the donor table is controlled by the following table closure algorithm. Let it be assumed that the poker tournament started with a total of T poker tables being numbered T(1) to T(T). Let it be further assumed that the poker table numbered 1 is designated to be the final table. Let it be further assumed that the poker table numbered T is designated to be the first poker table to be closed (a donor table), that the poker table numbered T-1 is designated to be the second poker table to be closed (a donor table) and so on until the poker table numbered 2 is designated the last poker table to be closed (a donor table) before leaving only final poker table 1. Let it be further assumed that each poker table numbered T(1) to T(T) starts with either P assigned players (or P-1 assigned players but not less than P-1 assigned players). In the examples herein, the poker tournament started with T=9 poker tables each with P=10 initially assigned players for a total of 90 entering players. For each poker table T(1) to T(T-1) (being table 8 in this example), add up or sum up all the remaining players at such poker tables 1-8. Such poker tables 1-8 began with a total of 80 players. If the difference between the original 80 players and the sum of all the remaining players at poker tables 1-8 is less than all the remaining players at poker table 9, then CPU 300 does not close poker table 9. If the difference between the original 80 players and the sum of all the remaining players at tables 1-8 is equal to or greater than all the remaining players at poker table 9, then CPU 300 closes poker table 9 (a donor table). Also, CPU randomly chooses all the remaining players at poker table 9 and then randomly re-assigns them in the table order T(1) to T(T-1) to either re-fill such poker tables (donee tables) in such order or to maximize (replenish) the number of players per poker table (donee table) in such order. After poker table 9 is closed, if at any time the difference between the original 70 players and the sum of all the remaining players at poker tables 1-7 is less than all the remaining players at poker table 8, then CPU 300 does not close poker table 8. If at any time the difference between the original 70 players and the sum of all the remaining players at poker tables 1-7 is equal to or greater than all the remaining players at poker table 8, then CPU 300 closes poker table 8 (donor table). Also, CPU randomly chooses all the remaining players at poker table 8 and randomly re-assigns them in the table order T(1) to T(T-2) to either re-fill such poker tables in such order or to maximize (replenish) the number of players per poker table in such order. This same process continues until poker table 4 is closed (donor table). When poker table 3 (donor table) is closed, all the remaining players at poker tables 1-3 are randomly re-assigned to poker tables 1-2. In other words, poker tables 1-2 are not just re-filled or replenished by adding onto their remaining players. All remaining players at poker table 1-3 are randomly re-assigned to either poker table 1 or poker table 2. In other words, a player who was at poker table 1 might be randomly re-assigned to poker table 2. A player who was poker table 3 might be randomly re-assigned to either poker table 1 or poker table 2.

When poker table 2 (donor table) is closed, all the remaining players at poker tables 1-2 are randomly re-assigned to poker table 1. In other words, poker table 1 is not just re-filled or replenished by adding onto the remaining players at poker table 1. All remaining players at poker tables 1-2 are randomly re-assigned to poker table 1. In other words, a player who was at poker table 1 will be randomly re-assigned to a new player position at poker table 1. A player who was poker table 2 will be randomly re-assigned to a new player position at poker table 1.

FIG. 8

FIG. 8 is an event/time listing showing the re-assignment of players from donor poker tables to donee poker tables, the replenishment of donee poker tables, the re-filling of donee poker tables, and the closure of donor poker tables during a poker tournament according to the present invention. At time t4, tables 1-9 each start full with 10 initially assigned players. At time t5, one player is eliminated from table 4 thereby leaving table 4 with 9 remaining players and leaving the rest of the tables each with 10 players. No action is taken by CPU 300 according to the pre-stored algorithms of the present invention. At time t6, one player is eliminated from table 2 thereby leaving tables 2 and 4 each with 9 remaining players and leaving the rest of the tables each with 10 players. Again, no action is taken by CPU 300 according to the pre-stored algorithms. At time t7, one player is eliminated from table 7 thereby leaving tables 2, 4 and 7 each with 9 remaining players and leaving the rest of the tables each with 10 players. Again, no action is taken by CPU 300 according to the pre-stored algorithms. At time t8, a second player is eliminated from table 4 thereby leaving table 4 with 8 remaining players, leaving tables 2 and 7 each with 9 remaining players, and leaving the rest of the tables each with 10 players. At this time t9, CPU 300 randomly chooses one of the remaining players from donor table 9 and re-assigns such chosen player to replenish donee table 4. At time t10, a second player is eliminated from table 2 thereby leaving 8 remaining players at table 2. Again, at this time t11, CPU 300 randomly chooses one of the remaining players from donor table 8 and re-assigns such chosen player to replenish donee table 2. At time t13, two players are eliminated from table 1 thereby leaving 8 remaining players at table 1. At this time CPU 300 randomly chooses one of the remaining players from donor table 6 and re-assigns such chosen player to replenish donee table 1. At time t16, two players are eliminated from table 1 and two players are eliminated from table 3 thereby leaving 7 remaining players at each such table. At this time CPU 300 randomly chooses the 9 players from donor table 9 and re-assigns three players to re-fill donee table 1, one player to re-fill donee table 2, three players to re-fill donee table 3, one player to re-fill donee table 4, and one player to re-fill donee table 5 for a total of 9 re-assigned players. CPU 300 then closes donor table 9 by de-activating dealer console 190 of FIG. 2 or by de-activating dealer console 190 and player consoles 90-99 of FIG. 3. The closure of a poker tournament table is significant because it frees a dealer and it frees a poker table and makes them available for the regular poker games. At time t18, CPU 300 randomly chooses the 9 players from donor table 8 and re-assigns them to re-fill donee tables 1-7 for a total of 9 re-assigned players. CPU 300 then closes donor table 8. At time t21, CPU 300 randomly chooses the 9 players from donor table 7 and re-assigns them to re-fill donee tables 1-6 for a total of 9 re-assigned players. CPU 300 then closes donor table 7. At time t26, CPU 300 randomly chooses the 9 players from donor table 6 and re-assigns them to re-fill or replenish donee tables 1-5 for a total of 9 re-assigned players. CPU 300 then closes donor table 6. At time t29, CPU 300 randomly chooses the 7 players from donor table 5 and re-assigns them to re-fill or replenish donee tables 1-4 for a total of 7 re-assigned players. CPU 300 then closes donor table 5. At time t32, CPU 300 randomly chooses the 7 players from donor table 4 and re-assigns them to re-fill donee tables 1-3 for a total of 7 re-assigned players. CPU 300 then closes donor table 4. At time t39, CPU 300 randomly chooses the 7 players from donor table 3, the 6 players from table 1, and the 7 players from table 2, and then randomly re-assigns all such 20 remaining players to new player positions at tables 1 and 2 for a total of 20 re-assigned players. CPU 300 then closes donor table 3. At time t48, CPU 300 randomly chooses the 5 players from table 2 and the 5 players from table 2, and then randomly re-assigns all such 10 remaining players to new player positions at final table 1 for a total of 10 re-assigned players. CPU 300 then closes donor table 2. Thereafter, the 10 remaining players at final table 1 continue to play against each other until all players but one are eliminated. The last remaining player is the winner of the tournament and gets the first prize money. The previously eliminated players collect their prize money according to the order in which they were eliminated and the tournament pay-off formula.

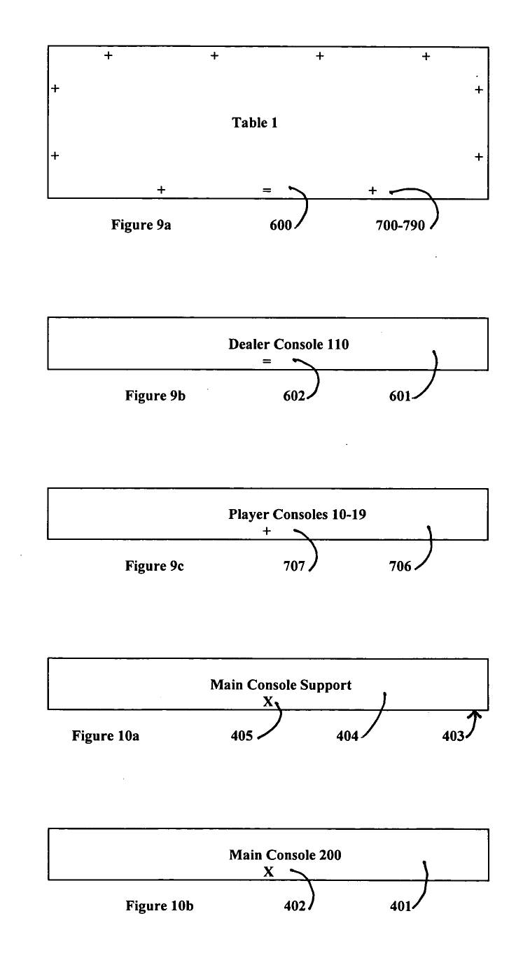

FIGS. 9a-c

FIGS. 9a-c show the modular plug-in features of dealer console DC 110 and player consoles PC 10-19 onto Table 1 according to the present invention. FIG. 9a shows Table 1, “=” shaped connector 600 for connecting to dealer console DC 110, and “+” shaped connectors 700-790 for respectively connecting to player consoles PC 10-19. FIG. 9b shows back side 601 of substantially flat dealer console DC 110 and “=” shaped connector 602 for connecting to “=” shaped connector 600 located on Table 1. FIG. 9c shows back side 706 of substantially flat player consoles PC 10-19 and “+” shaped connector 707 for connecting to “+” shaped connector 700-790 on Table 1.

FIGS. 10a-b

FIGS. 10a-b show the modular plug-in features of main console MC 200 onto its support structure according to the present invention. FIG. 10a shows back side 404 of main console support 403 and “X” shaped connector 405 for connecting to main console MC 200. FIG. 10b shows back side 401 of substantially flat main console MC 200 and “X” shaped connector 402 for connecting to “X” shaped connector 405 of main console support 403.

While the present invention has been described in terms of specific illustrative embodiments, it will be apparent to those skilled in the art that many other embodiments and modifications are possible within the spirit and scope of the disclosed principle.

1. A system for allowing a plurality of players to enter and participate in a player-elimination poker tournament utilizing up to T poker tables designated tables T(1) to T(T), each poker table having up to P player positions designated P(1) to P(P), said system comprising:
a central processing unit;
at least one main console; and
a plurality of first signal transmitting means for allowing each main console and said central processing unit to send signals to each other and to receive signals from each other;
at least one main console further comprising entering player information accessing means; and
said central processing unit responding to the entering player information accessed by said accessing means for initially randomly assigning each entering player to a specific player position chosen from P(1) to P(P) at a specific poker table chosen from T(1) to T(T).

2. In the system of claim 1, said central processing unit storing the accessed entering player information, the initially assigned player position, and the initially assigned poker table for each player entering the tournament.

3. In the system of claim 1, said central processing unit effecting the re-assignment of at least one randomly chosen player from at least one donor poker table to at least one donee poker table such that the resulting number of players assigned to each poker table differs by no more than a specified maximum difference.

4. In the system of claim 3, said central processing unit storing the player re-assignment history for such donor and donee poker tables.

5. In the system of claim 1, said central processing unit effecting the re-assignment of at least one player from at least one donor poker table to a donee poker table such that the resulting number of players assigned to such donee poker table is equal to the maximum number of players allowed at any poker table.

6. In the system of claim 5, said central processing unit storing the player re-assignment history for such donor and donee poker tables.

7. In the system of claim 1, said central processing unit effecting the re-assignment of all players from a donor poker table to at least one donee poker table, such that the resulting number of players assigned to all poker tables differs by no more than a specified maximum difference, such that the resulting number of players assigned to each poker table is equal to or less than the maximum number of players allowed at any poker table, and such that the donor poker table is closed or deactivated after such player re-assignments.

8. In the system of claim 7, said central processing unit storing the poker table closure history for such donor poker tables.

9. In the system of claim 1, said central processing unit having a pre-stored tournament schedule.

10. In the system of claim 1, said central processing unit having a pre-stored tournament pay-off schedule.

11. In the system of claim 1, said central processing unit having a pre-stored betting limit schedule.

12. In the system of claim 1, said central processing unit having a pre-stored forced ante schedule.

13. In the system of claim 3, said central processing unit storing the accessed player information, the latest re-assigned player position, and the latest re-assigned poker table for each player remaining in the tournament.

14. The system of claim 1 also comprising:
a secondary central processing unit; and
second signal transmitting means for allowing said secondary central processing unit and said central processing unit to send signals to each other and to receive signals from each;
said secondary central processing unit responding to said central processing unit for continually storing all the information being stored in said central processing unit.

15. In the system of claim 1, at least one main console further comprising display means.

16. In the system of claim 15, at least one main console also further comprising selective actuating means for causing said main console display means to display selected information stored in said central processing unit.

17. In the system of claim 16, at least one main console also further comprising display clearing means for clearing the information being displayed on said main console display means.

18. In the system of claim 15, at least one main console also further comprising printing means.

19. In the system of claim 18, at least one main console also further comprising means for causing said main console printing means to print the information being displayed on said main console display means.

20. In the system of claim 1, said entering player information accessing means being swiping reading means.

21. In the system of claim 1, said player information entering means being a magnetic reading means.

22. The system of claim 1 also comprising:
a dealer console at each poker table; and
a plurality of third signal transmitting means for allowing the dealer console at each poker table and said central processing unit to send signals to each other and to receive signals from each other.

23. In the system of claim 22, the dealer console at each poker table further comprising display means.

24. In the system of claim 23, the dealer console at each poker table also further comprising selective actuating means for causing its dealer console display means to display selected information stored in said central processing unit.

25. In the system of claim 24, the dealer console at each poker table also further comprising display clearing means for clearing the information displayed on said dealer console display means.

26. In the system of claim 24, at least one main console also further comprising display means and dealer console selective actuating means for causing said main console display means to display such dealer console selected information stored in said central processing unit.

27. In the system of claim 23, the dealer console at each poker table also further comprising printing means.

28. In the system of claim 27, the dealer console at each poker table also further comprising means for causing its dealer console printing means to print the information being displayed on its dealer console display means.

29. In the system of claim 22, said central processing unit activating the dealer console at each initially assigned poker table.

30. In the system of claim 22, the dealer console at each poker table further comprising dealer information accessing means; said central processing unit storing such accessed dealer information, the dealer log-in time, the dealer log-out time, and the dealer's assigned poker table.

31. In the system of claim 22, the dealer console at each poker table further comprising eliminated player information accessing means, said central processing unit storing such eliminated player information accessed by the dealer console at each poker table.

32. In the system of claim 31, said central processing unit storing for each player eliminated from the tournament the player information, the last assigned player position and the last assigned poker table.

33. In the system of claim 23:
the dealer console at each poker table further comprising betting order entering means;
said central processing unit storing the betting order received from the dealer console at each poker table; and
the dealer console at each poker table further comprising means for causing its dealer console display means to display the betting order at its poker table.

34. The system of claim 1 also comprising:
a plurality of up to P player consoles at each poker table; and
a plurality of fourth signal transmitting means for allowing each player console at each poker table and said central processing unit to send signals to each other and to receive signals from each other.

35. In the system of claim 34, each player console at each poker table further comprising display means.

36. In the system of claim 35, each player console at each poker table also further comprising selective actuating means for causing its player console display means to display selected information stored in said central processing unit.

37. In the system of claim 36, each player console at each poker table also further comprising display clearing means for clearing the information being displayed on its player console display means.

38. In the system of claim 36, at least one main console also further comprising display means and player console selective actuating means for causing said main console display means to display such player console selected information stored in said central processing unit.

39. In the system of claim 35, each player console at each poker table also further comprising printing means.

40. In the system of claim 39, each player console at each poker table also further comprising means for causing its player console printing means to print the information being displayed on its player console display means.

41. In the system of claim 34,- said central processing unit activating each initially assigned player console at each initially assigned poker table.

42. The system of claim 33 also comprising:
a plurality of up to P player consoles at each poker table, each player console further comprising display means; and
a plurality of fourth signal transmitting means for allowing each player console at each poker table and said central processing unit to send signals to each other and to receive signals from each other;
each player console at each poker table also further comprising means for causing its player console display means to display the betting order at its poker table.

43. In the system of claim 34, the player consoles at each poker table being removably attached to such poker table and being distributed to accommodate the players at such poker table.

44. In the system of claim 22, the dealer console at each poker table being removably attached to such poker table and being located to accommodate the dealer at such poker table.

45. In the system of claim 1, each main console being removably attached to its associated support structure.

46. In the system of claim 31, said central processing unit comparing such stored eliminated player information relative to the minimum number of players allowed at any poker table for re-assigning at least one randomly chosen player from at least one donor poker table to replenish a donee poker table that has less than such minimum number of players allowed at any poker table.

47. In the system of claim 46, such donor poker tables being preferably chosen in order according to the pre-stored table sequence T(T) to T(1).

48. In the system of claim 46, such donee poker table being preferably chosen according to the pre-stored table sequence T(1) to T(T).

49. In the system of claim 31, said central processing unit comparing such stored eliminated player information relative to the cumulative number of players remaining at all poker tables for randomly re-assigning all the remaining players from a donor poker table to re-fill or replenish one or more donee poker tables and for closing such donor poker table.

50. In the system of claim 49, such donee poker tables being preferably chosen in order according to the pre-stored table sequence T(1) to T(T).

51. In the system of claim 49, such closed donor poker table being chosen according to the pre-stored table sequence T(T) to T(1).

52. In the system of claim 31, said central processing unit comparing such stored eliminated player information relative to the maximum difference in the number of players remaining at the most populated poker tables relative to the least populated poker table for re-assigning at least one randomly chosen player from at least one most populated donor poker table to replenish such least populated donee poker table.

53. In the system of claim 52, such most populated donor poker tables being preferably chosen in order according to the pre-stored table sequence T(T) to T(1).

54. In the system of claim 52, such least populated donee poker table being preferably chosen according to the pre-stored table sequence T(1) to T(T).

55. In the system of claim 31, said central processing unit responding to such stored eliminated player information accessed by the dealer console at each poker table for re-assigning at least one randomly chosen player from at least one donor poker table to replenish a donee poker table in order to make the number of players at such donee poker table equal to or one less than the maximum number of players remaining at any other poker table, such donor poker tables remaining open after such player re-assignment is effected.

56. In the system of claim 55, said chosen player re-assignment being preferably effected as to such donor poker tables according to the pre-stored table sequence T(T) to T(1).

57. In the system of claim 55, said chosen player re-assignment being preferably effected as to such donee poker table according to the pre-stored table sequence T(1) to T(T).

58. In the system of claim 31, said central processing unit responding to such stored eliminated player information received from the dealer console at each poker table for randomly re-assigning all the players from a chosen donor poker table to re-fill or replenish at least one donee poker table in order to make the number of players at any poker table other than such chosen donor poker table equal to the higher or lower of two consecutive numbers, such chosen donor poker table being closed after such player re-assignments are effected.

59. In the system of claim 58, said player re-assignments being preferably effected as to such chosen donor poker table according to the pre-stored table sequence T(T) to T(1).

60. In the system of claim 58, said player re-assignments being preferably effected as to such donee poker tables according to the pre-stored table sequence T(1) to T(T).

61. In the system of claim 7, said central processing unit storing the player re-assignment history for such donor and donee poker tables.

62. In the system of claim 5, said central processing unit storing the accessed player information, the latest re-assigned player position, and the latest re-assigned poker table for each player remaining in the tournament.

63. In the system of claim 7, said central processing unit storing the accessed player information, the latest re-assigned player position, and the latest re-assigned poker table for each player remaining in the tournament.

64. In the system of claim 1, said central processing unit having a pre-stored little blind and big blind schedule.
